(19) United States
(12) Patent Application Publication
(10) Pub. No.: US 2015/0098740 A1
(43) Pub. Date: Apr. 9, 2015

(54) PRINT CONTROL DEVICE, PRINT CONTROL METHOD, AND COMPUTER-READABLE STORAGE MEDIUM

(71) Applicant: Itsuo YUKIE, Tokyo (JP)

(72) Inventor: Itsuo YUKIE, Tokyo (JP)

(21) Appl. No.: 14/484,722

(22) Filed: Sep. 12, 2014

(30) Foreign Application Priority Data
Oct. 4, 2013 (JP) 2013-209685

(51) Int. Cl. G03G 15/20

(52) U.S. Cl. CPC G03G 15/2039; G03G 15/6585
USPC 399/341

(57) ABSTRACT

A print control device includes an image data generating unit that generates image data based on gloss-control plane data for specifying a type of a surface effect to be applied to a recording medium and an area in the recording medium to which the surface effect is applied. The image data generating unit generates image data used to fix only a clear toner at a first fixing in response to an instruction to perform a plurality of fixings.

### CROSS-REFERENCE TO RELATED APPLICATIONS

The present application claims priority to and incorporates by reference the entire contents of Japanese Patent Application No. 2013-209685 filed in Japan on Oct. 4, 2013. The present document incorporates by reference the entire contents of Japanese Patent Application No. 2013-054428 filed in Japan on Mar. 15, 2013.

### BACKGROUND OF THE INVENTION

1. Field of the Invention

The present invention relates to a print control device, a print control method, and a computer-readable storage medium.

2. Description of the Related Art

Conventionally, there is an image forming apparatus with a clear toner that is a colorless toner including no color material in addition to toners in four colors of cyan (C), magenta (M), yellow (Y), and black (K). A toner image formed with the clear toner is fixed on a recording medium such as a transfer sheet on which an image has been formed with the CMYK toners, and a visual effect and a tactile effect (hereinafter, “surface effect”) are thereby realized on the surface of the recording medium.

The surface effect to be realized differs depending on what toner image is formed with the clear toner and how the clear toner is fixed. Some surface effects simply apply gloss and other surface effects suppress gloss. Various surface effects are required, such as a surface effect applied to an entire surface, a surface effect applied to part of the surface, or a surface effect such that a texture or a watermark is applied to the surface using a clear toner. Surface protection may also be required.

Some surface effects can be achieved by causing a special post-processing device such as a glosser or a low-temperature fixing device to perform post-processing as well as to control fixing. Recently, as disclosed in, for example, Japanese Laid-open Patent Publication No. 2011-150158, a technology of attaching a clear toner only to a desired portion in part of a surface and applying gloss thereto is developed.

Japanese Laid-open Patent Publication No. 2010-91813 discloses a technology for an image forming apparatus, for the purpose of achieving a printing effect desired by a user, that automatically sets a type of sheet, transparent form image data, and a print output method in order to achieve the printing effect, and that prints and outputs an image.

However, in the conventional gloss control technology, the smoothness of a sheet surface is required when the surface effect is applied thereto in order to increase glossiness of the specified area. Therefore, when the sheet has large surface roughness, there arises a problem that the surface effect intended by the user may not be obtained.

Therefore, there is a need to provide a print control device, a print control method, and a computer-readable storage medium capable of obtaining a user-intended surface effect in a specified area to which the surface effect of increasing glossiness is applied even when the sheet has large surface roughness and capable of smoothing surface roughness of a sheet when the sheet has large surface roughness even when there is no specified area to which the surface effect of increasing glossiness is applied.

### SUMMARY OF THE INVENTION

It is an object of the present invention to at least partially solve the problems in the conventional technology.

According to an embodiment, there is provided a print control device that includes an image data generating unit that generates image data based on gloss-control plane data for specifying a type of a surface effect to be applied to a recording medium and an area in the recording medium to which the surface effect is applied. The image data generating unit generates image data used to fix only a clear toner at a first fixing in response to an instruction to perform a plurality of fixings.

According to another embodiment, there is provided a print control method that includes generating image data based on gloss-control plane data for specifying a type of a surface effect to be applied to a recording medium and an area in the recording medium to which the surface effect is applied. The generating includes generating image data used to fix only a clear toner at a first fixing in response to an instruction to perform a plurality of fixings.

According to still another embodiment, there is provided a non-transitory computer-readable storage medium with an executable program stored thereon and executed by a computer. The program instructs the computer to perform: generating image data based on gloss-control plane data for specifying a type of a surface effect to be applied to a recording medium and an area in the recording medium to which the surface effect is applied. The generating includes generating image data used to fix only a clear toner at a first fixing in response to an instruction to perform a plurality of fixings.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of a configuration example of an image forming system according to a first embodiment;

FIG. 2 is a diagram of an example of color plane image data;

FIG. 3 a diagram of types of surface effects relating to the presence or absence of gloss;

FIG. 4 is a diagram of gloss-control plane image data as an image;

FIG. 5 is a diagram of an example of clear plane image data;

FIG. 6 is a diagram of an example of a density value selection table;

FIG. 7 is a diagram of a correspondence relation between a drawing object, a coordinate, and a density value of the gloss-control plane image data illustrated in FIG. 4;

FIG. 8 is a schematic diagram of a conceptual configuration example of print data;

FIG. 9 is a diagram of a functional configuration of a DFE;

FIG. 10 is a diagram of a functional configuration of clear processing according to the first embodiment;

FIG. 11 is a diagram of a data structure of a surface effect selection table;

FIG. 12 is a diagram of an example of a sheet list;

FIG. 13 is a diagram of an example of an input screen of print setting;

FIG. 14 is a diagram of a conceptual configuration of an MIC and a printing device;

FIG. 15 is a block diagram of a functional configuration of a printer machine;

FIG. 16 is a flowchart of a procedure of gloss control processing performed by the image forming system according to the first embodiment;

FIG. 17 is a flowchart of a procedure of image processing performed by the clear processing;

FIG. 18 is a flowchart of a procedure of first clear-toner plane data generation processing;

FIG. 19 is a flowchart of a procedure of second clear-toner plane data generation processing;

FIG. 20 is a flowchart of a procedure of print processing when clear toner plane data for applying a surface effect is generated;

FIG. 21 is a flowchart of a procedure of print processing when clear toner plane data for smoothing a sheet surface is generated;

FIG. 22 is a block diagram of a functional configuration of a DFE according to a second embodiment;

FIG. 23 is a flowchart of a procedure of output control processing according to the second embodiment;

FIG. 24 is a flowchart of a procedure of the output control processing according to the second embodiment;

FIG. 25 is a diagram of an example of a setting instruction screen for a print sheet according to the second embodiment;

FIG. 26 is a diagram of an example of a charge setting screen according to the second embodiment;

FIG. 27 is a diagram of a configuration of an image forming system according to a third embodiment;

FIG. 28 is a block diagram of a functional configuration of a server device according to the third embodiment;

FIG. 29 is a block diagram of a functional configuration of a DFE according to the third embodiment;

FIG. 30 is a sequence diagram of the overall flow of clear-toner plane generation processing according to the third embodiment;

FIG. 31 is a diagram of a network configuration in which two servers are provided in a cloud; and

FIG. 32 is a hardware configuration diagram of the host device, the DFE, and the server device.

### DETAILED DESCRIPTION OF THE PREFERRED EMBODIMENTS

Exemplary embodiments of the print control device, the print control system, the print control method, and the computer program product will be explained in detail below with reference to the accompanying drawings.

First of all, a configuration of an image forming system according to a first embodiment will be explained below. In the present embodiment, the image forming system includes a printer control device (digital front end (DFE)) 50 (hereinafter, “DFE 50”), an interface controller (mechanism I/F controller (MIC)) 60 (hereinafter, “MIC 60”), a printer machine 70, and a glosser 80 and a low-temperature fixing device 90 which function as post-processing devices, all of which are connected to each other. The DFE 50 performs communication with the printer machine 70 via the MIC 60 and controls the printer machine 70 to form an image. The DFE 50 is connected with a host device 10 such as a personal computer (PC). The DFE 50 receives image data from the host device 10, generates image data used when the printer machine 70 forms a toner image according to respective toners of CMYK and a clear toner using the received image data, and transmits the generated image data to the printer machine 70 via the MIC 60. The printer machine 70 is provided with at least respective toners of CMYK and a clear toner, and is provided with an image forming unit that includes a photoconductor, a charger, a developing device, and a photoconductor cleaner; an exposing unit; and a fixing unit for each toner.

The printer machine 70, the glosser 80, and the low-temperature fixing device 90 constitute a printing device 30.

The clear toner is a transparent (colorless) toner without a color material. The “transparent (colorless)” indicates, for example, a transmittance of 70% or more.

The printer machine 70 irradiates a light beam from the exposing unit according to the image data transmitted from the DFE 50 via the MIC 60 to form a toner image according to respective toners on the photoconductor, transfers the toner image on a sheet as a recording medium, and causes the fixing unit to fix the toner image on the sheet by being applied with heat and pressure at a temperature (normal temperature) within a predetermined range. The image is thereby formed on the sheet. The configuration of the printer machine 70 is known, and therefore detailed explanation thereof is omitted herein. The sheet is only an example of the recording medium, and therefore the recording medium is not limited thereto. For example, a synthetic paper, a vinyl paper, and the like can also be applied as the recording medium.

The glosser 80 is on/off controlled by on-off information specified from the DFE 50. When it is turned on, the glosser 80 pressures the image formed on the sheet by the printer machine 70 at a high temperature and a high pressure, then cools the image, and separates the sheet with the image formed thereon from its main body. Thereby a total adhesion amount of toners in respective pixels to which the toners of predetermined amount or more are attached over the image formed on the sheet is uniformly compressed. The low-temperature fixing device 90 is provided with an image forming unit that includes a photoconductor, a charger, a developing device, and a photoconductor cleaner for a clear toner; an exposing unit; and a fixing unit for fixing the clear toner. Clear-toner plane image data (hereinafter sometimes called “clear toner plane data”) (explained later) generated by the DFE 50 is received in order to use the low-temperature fixing device 90. When the DFE 50 generates the clear toner plane data used by the low-temperature fixing device 90, the low-temperature fixing device 90 uses the data to form a toner image using the clear toner, superimposes the toner image on the sheet pressured by the glosser 80, and causes the fixing unit to fix the image on the sheet by applying heat or pressure lower than normal.

Image data (document data) input from the host device 10 will be explained below. The host device 10 generates image data by a preinstalled image processing application and transmits the image data to the DFE 50. The image processing application can handle special-color plane image data for image data in which a value of density (called density value) of each color in respective color planes of RGB planes and CMYK planes is defined for each pixel. The special-color plane is image data for attaching a special toner or ink such as white, gold, or silver in addition to basic colors such as CMYK and RGB, and is data for a printer provided with such a special toner or ink. The special-color plane may be used to add R to the CMYK basic colors or Y to the RGB basic colors in order to improve color reproducibility. In general, the clear toner is also handled as one of the special colors.

In the present embodiment, the clear toner as the special color is used to form a surface effect which is a visual effect or a tactile effect to be applied to a sheet and to form a transparent image such as a watermark and texture other than the surface effect on the sheet.

Therefore, the image processing application of the host device 10 generates any one or both of gloss-control plane image data (hereinafter sometimes called “gloss-control plane data”) and clear plane image data (hereinafter sometimes called “clear plane data”) as the special-color plane image data, according to user's specification, in addition to color plane image data (hereinafter sometimes called “color plane data”) with respect to the input image data.

The color plane data is image data in which a density value of respective chromatic colors such as RGB and CMYK is defined for each pixel. In the color plane data, one pixel is expressed by 8 bits according to a color specified by the user. FIG. 2 is an explanatory diagram of an example of color plane data. As illustrated in FIG. 2, a density value corresponding to a color specified by the user using the image processing application is given to each drawing object such as “A”, “B”, and “C”.

The gloss-control plane data is image data in which an area to be applied with a surface effect and a type of the surface effect are specified in order to control so as to attach a clear toner according to the surface effect which is a visual effect or a tactile effect to be applied to a sheet.

The gloss-control plane is represented by a density value in a range of 0 to 255 with 8 bits for each pixel similarly to the color plane such as RGB and CMYK, and a type of the surface effect is associated with the density value (the density value may be expressed by 16 bits, 32 bits, or 0 to 100%). The same value is set in a range to which the same surface effect is desired to be applied regardless of the density of the clear toner that actually adheres, and therefore an area can be easily identified from the image data as necessary even if there is no data indicating the area. In other words, the type of the surface effect and the area to which the surface effect is applied are represented by the gloss-control plane (the data indicating the area may be separately provided).

The host device 10 sets a type of a surface effect to be applied to each drawing object specified by the user using the image processing application, as a density value being a gloss control value for each drawing object, and generates the gloss-control plane data in a vector format.

Pixels forming the gloss-control plane data correspond to respective pixels of the color plane data. In each image data, a density value indicating each pixel is a pixel value. The color plane data and the gloss-control plane data are formed page by page.

The types of the surface effects are roughly classified into those relating to the presence or absence of gloss, a surface protection, a watermark in which information is embedded, and a texture. As exemplified in FIG. 3, there are four major types of the surface effects relating to the presence or absence of gloss, which are represented in a descending order of the degree of gloss (glossiness), such as specular gloss as Premium Gloss (PG), solid gloss as Gloss (G), halftone matte as Matt (M), and delustered as Premium Matt (PM). Hereinafter, the specular gloss may be called “PG”, the solid gloss “G”, the halftone matte “M”, and the delustered “PM”.

The specular gloss and the solid gloss apply a high degree of gloss. On the other hand, the halftone matte and the delustered are used to suppress gloss. Particularly, the delustered is used to obtain a glossiness lower than a glossiness of a normal sheet. As illustrated in FIG. 3, the specular gloss represents a glossiness Gs of 80 or higher, the solid gloss represents a solid glossiness made by a primary color or a secondary color, the halftone matte represents a glossiness made by a primary color and having a glossiness of 30% halftone dots, and the delustered represents a glossiness of 10 or lower. The deviation in glossiness is represented by ΔGs and is set to 10 or less. A higher density value is associated with a surface effect that requires a higher degree of gloss, and a lower density value is associated with a surface effect that suppresses gloss. An intermediate density value is associated with a surface effect such as a watermark and texture. The watermark is, for example, a character and a background pattern. The texture represents a character and a pattern, and can provide a tactile effect in addition to a visual effect. For example, a pattern of a stained glass can be obtained by a clear toner. The surface protection is substituted by the specular gloss or the solid gloss. An area of an image, which is represented by image data for target processing, applied with a surface effect and a type of the surface effect to be applied to the area are specified by the user via the image processing application. The host device 10 that executes the image processing application generates gloss-control plane data by setting a density value corresponding to the surface effect specified by the user for a drawing object that forms the area specified by the user. A correspondence relation between the density value and the type of the surface effect will be explained later.

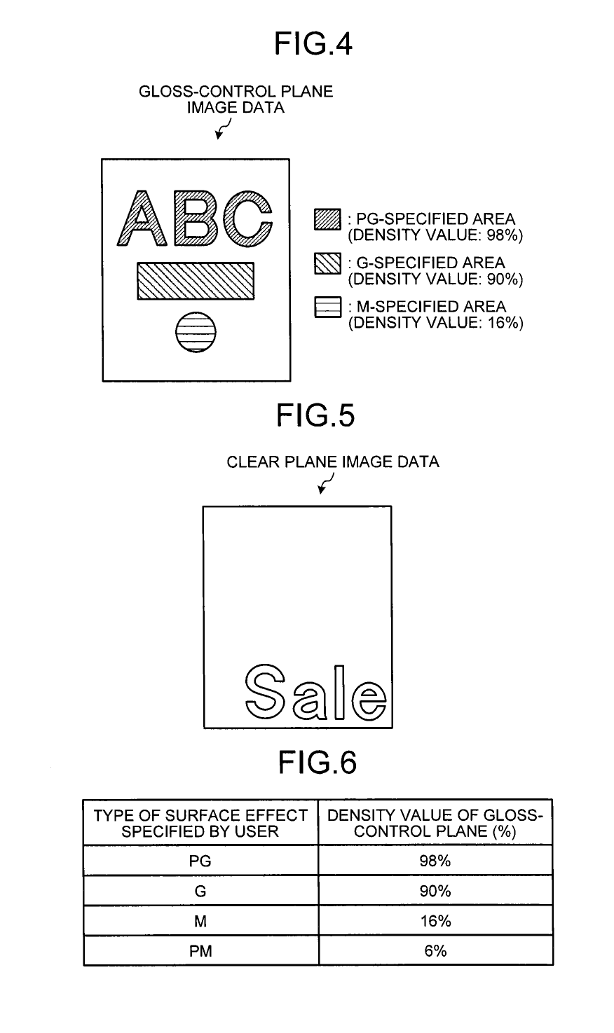

FIG. 4 is an explanatory diagram of an example of gloss-control plane data. In the example of the gloss-control plane in FIG. 4, the user allocates the surface effect “PG (Premium Gloss)” to a drawing object “ABC”, the surface effect “G (Gloss)” to a drawing object “rectangle”, and the surface effect “M (Matt)” to a drawing object “circle”. The density value set in each surface effect is a density value defined in association with the type of the surface effect in a density value selection table explained later (see FIG. 6).

The clear plane data is image data that identifies a transparent image such as a watermark and texture other than the surface effects. FIG. 5 is an explanatory diagram of an example of clear plane data. In the example of FIG. 5, a watermark “Sale” is specified by the user.

The gloss-control plane data and the clear plane data which are the special-color plane image data are generated in a plane different from the color plane data by the image processing application of the host device 10. As each format of the color plane data, the gloss-control plane data, and the clear plane data, a Portable Document Format (PDF) is used, and PDF image data of the planes are integrated and generated as document data. The data format of the image data of each plane is not limited to PDF and therefore an arbitrary format may be used.

The image processing application of the host device 10 converts the type of the surface effect specified by the user into a density value to generate gloss-control plane data. The conversion is performed by referring to the density value selection table previously stored in a storage unit of the host device 10. The density value selection table is table data in which a type of the surface effect is associated with a density value of the gloss-control plane corresponding to the type of the surface effect. FIG. 6 is a diagram of an example of the density value selection table. In the example of FIG. 6, the density value of the gloss-control plane corresponding to the area where “PG” (Premium Gloss) is specified by the user is a pixel value corresponding to “98%”, the density value of the gloss-control plane corresponding to the area where “G” (Gloss) is specified is a pixel value corresponding to “90%”, the density value of the gloss-control plane corresponding to the area where “M” (Matt) is specified is a pixel value corresponding to “16%”, and the density value of the gloss-control plane corresponding to the area where “PM” (Premium Matt) is specified is a pixel value corresponding to “6%”.

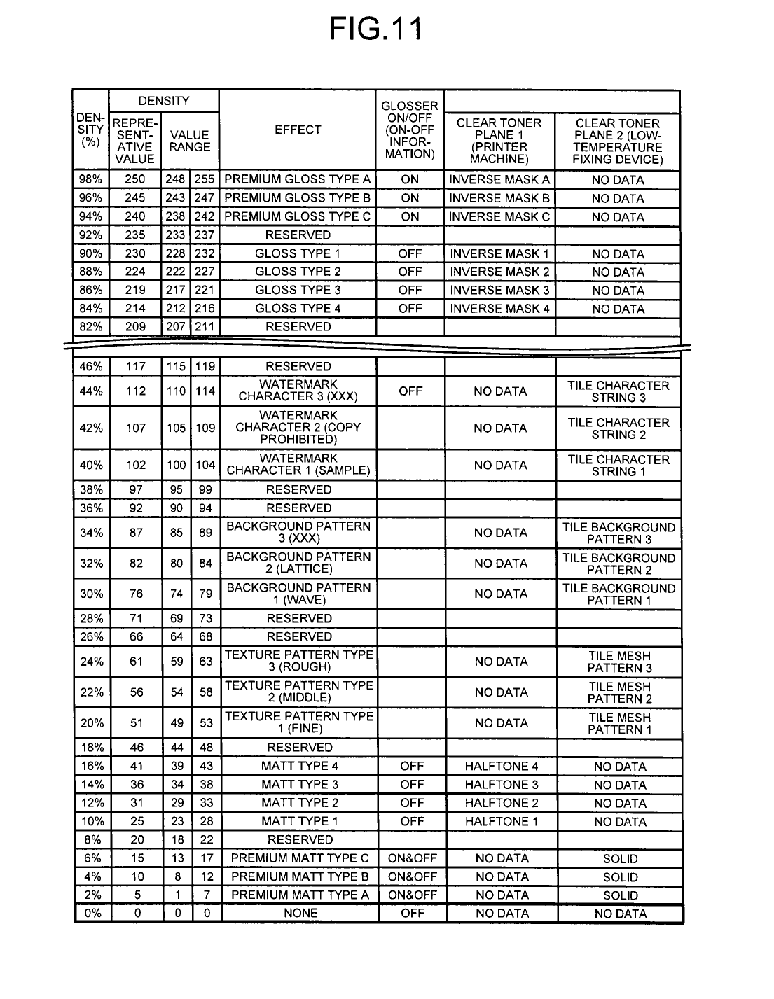

The density value selection table is the same data as a surface effect selection table (explained later) stored in the DFE 50. A control unit of the host device 10 acquires the surface effect selection table at a predetermined timing, generates (copies) a density value selection table from the acquired surface effect selection table, and stores the density value selection table in the storage unit. FIG. 6 depicts a simplified example of the density value selection table; however, the density value selection table is actually the same table as the surface effect selection table illustrated in FIG. 11. It may be configured so that the surface effect selection table is stored in a storage server (cloud) on a network such as the Internet and the control unit acquires the surface effect selection table from the server to generate (copy) a density value selection table from the acquired surface effect selection table. However, the surface effect selection table stored in the DFE 50 needs to be the same data as the surface effect selection table stored in the storage unit of the host device.

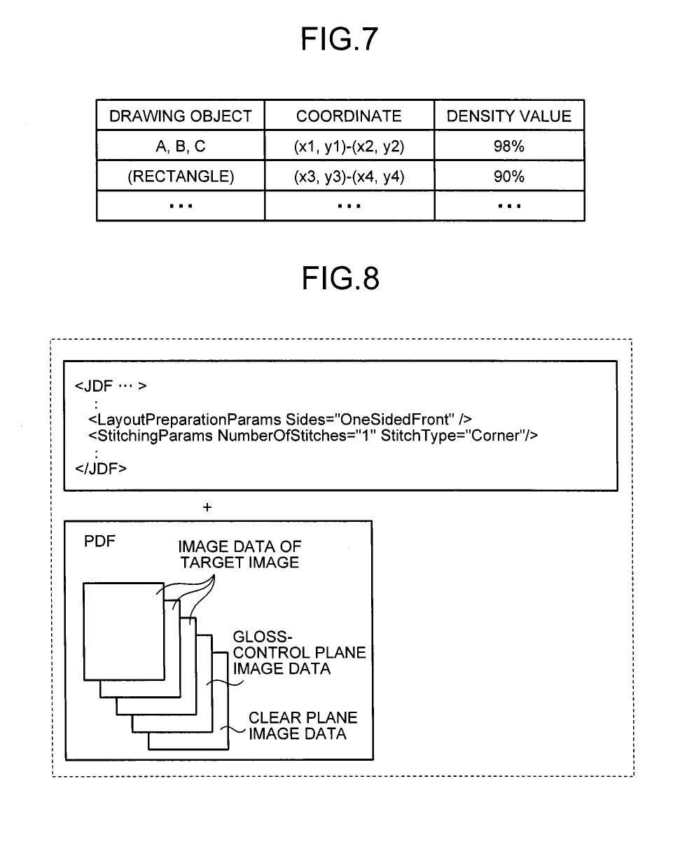

Specifically, the image processing application of the host device 10 generates gloss-control plane data by setting a density value (gloss control value) of a drawing object to which a predetermined surface effect is specified by the user as a value corresponding to the type of the surface effect while referring to the density value selection table illustrated in FIG. 6. For example, it is assumed that the user specifies that, of the target images being color plane data illustrated in FIG. 2, “PG” is applied to the area of “ABC”, “G” is applied to the area of rectangle, and “M” is applied to the area of circle. In this case, the host device 10 refers to the density value selection table to set the density value of the “PG”-specified drawing object (“ABC”) by the user to the pixel value corresponding to “98%”, the density value of the “G”-specified drawing object (“rectangle”) to the pixel value corresponding to “90%”, and the density value of the “M”-specified drawing object (“circle”) to the pixel value corresponding to “16%”, thus generating gloss-control plane data. The gloss-control plane data generated by the host device 10 is the data in the vector format expressed as a set of coordinates of points, parameters of equations for lines and planes connecting the points, and of drawing objects indicating filling and special effects or so. FIG. 4 is a diagram illustrating the gloss-control plane data as an image, and FIG. 7 is a diagram of a correspondence relation between the drawing object, the coordinate, and the density value of the gloss-control plane data illustrated in FIG. 4.

The host device 10 generates document data in which the gloss-control plane data, the image data (color plane data) of a target image, and the clear plane data are integrated.

The host device 10 then generates print data based on the document data. The print data includes the image data (color plane data) of a target image, the gloss-control plane data, the clear plane image data, and job commands for specifying, for example, setting of a printer, setting of combined printing (printing multiple pages per sheet), and setting of duplex printing for the printer. FIG. 8 is a schematic diagram of a conceptual configuration example of the print data. In the example of FIG. 8, a job definition format (JDF) is used as the job command; however, the job command is not limited thereto. The JDF illustrated in FIG. 8 is a command for specifying “one-side printing, stapling” as the setting of combined printing. The print data may be converted into a page description language (PDL) like PostScript or may remain in the PDF if the DFE 50 can handle it.

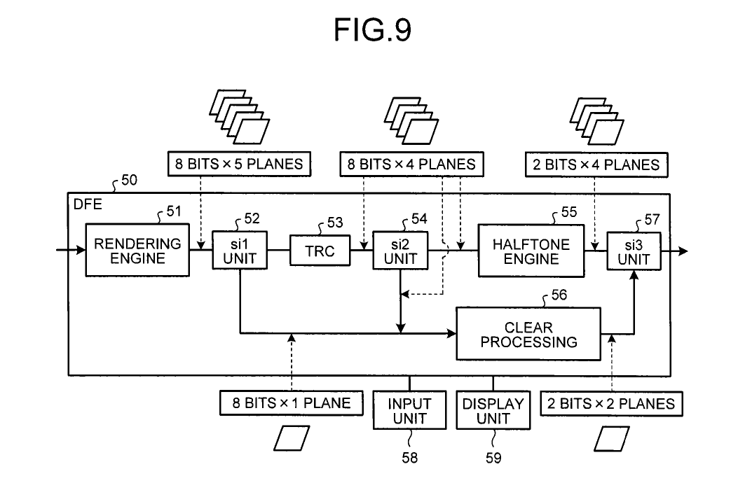

A functional configuration of the DFE 50 will be explained next. As exemplified in FIG. 9, the DFE 50 includes a rendering engine 51, an si1 unit 52, a tone reproduction curve (TRC) 53, an si2 unit 54, a halftone engine 55, a clear processing 56, an si3 unit 57, an input unit 58, and a display unit 59. The rendering engine 51, the si1 unit 52, the TRC 53, the si2 unit 54, the halftone engine 55, the clear processing 56, and the si3 unit 57 are implemented by causing a control unit of the DFE 50 to execute various programs stored in a main storage unit or in an auxiliary storage unit. Each of the si1 unit 52, the si2 unit 54, and the si3 unit 57 has a function of separating image data and a function of integrating image data.

In the following, an example will be explained in which the print data is formed by including at least color plane data, in which the gloss-control plane data may not be included therein, and in which the clear plane data may not be included therein. However, the clear plane data may be included in the print data.

The input unit 58 is an input device such as a keyboard and a mouse. The input unit 58 receives an input of various settings (print setting, start/cancel of printing) from the user. The display unit 59 is a display device such as a display. The display unit 59 performs a display of print setting and the like to the user.

The rendering engine 51 receives the print data (the print data illustrated in FIG. 8) transmitted from the host device 10. The rendering engine 51 interprets the language of the received image data, converts the image data expressed in the vector format into image data in a raster format, converts a color space expressed in an RGB format into a color space in a CMYK format, and outputs respective 8-bit color plane data of CMYK and 8-bit gloss-control plane data. The si1 unit 52 outputs the respective 8-bit color plane data of CMYK to the TRC 53 and outputs the 8-bit gloss-control plane data to the clear processing 56. The DFE 50 converts the gloss-control plane data in the vector format output from the host device 10 into gloss-control plane data in the raster format. As a result, the DFE 50 sets the type of a surface effect to be applied to the drawing object specified by the user via the image processing application as a density value for each pixel, and outputs the gloss-control plane data.

The TRC 53 receives the respective 8-bit image data of CMYK via the si1 unit 52. The TRC 53 performs gamma correction on the received image data by using a gamma curve of a one-dimensional lookup table (1D_LUT) generated by calibration. The image processing includes total amount control of toner or the like in addition to the gamma correction. The total amount control is processing for limiting the respective 8-bit color plane data of CMYK after the gamma correction because the amount of toner capable of being attached to one pixel on a recording medium is limited in the printer machine 70. When printing is performed beyond the total amount control, the image quality is degraded due to a transfer failure or a fixing failure. In the present embodiment, only related gamma correction will be explained below.

The si2 unit 54 outputs the respective 8-bit color plane data of CMYK which are gamma corrected by the TRC 53 as data for generating inverse mask (explained later) to the clear processing 56. The halftone engine 55 receives the respective 8-bit color plane data of CMYK after the gamma correction via the si2 unit 54. The halftone engine 55 performs halftone processing for converting the received image data into a data format of, for example, respective 2-bit color plane data of CMYK in order to output the received image data to the printer machine 70, and outputs the respective 2-bit color plane data of CMYK after the halftone processing. However, 2 bits are only an example, and the number of bits is not therefore limited thereto.

The clear processing 56 receives the 8-bit gloss-control plane data converted by the rendering engine 51 via the si1 unit 52 and also receives the respective 8-bit color plane data of CMYK gamma-corrected by the TRC 53 via the si2 unit 54.

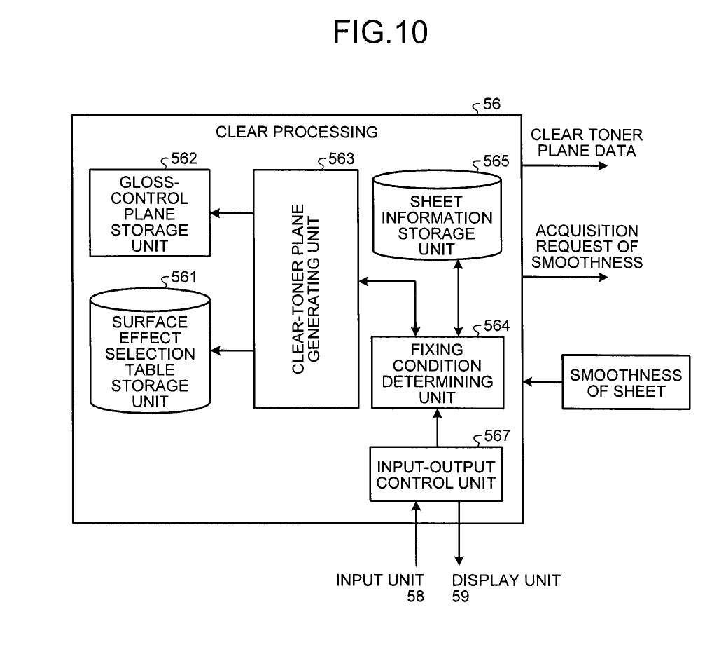

FIG. 10 is a block diagram of a functional configuration of the clear processing 56. As illustrated in FIG. 10, the clear processing 56 includes a surface effect selection table storage unit 561, a gloss-control plane storage unit 562, a clear-toner plane generating unit 563, a sheet information storage unit 565, a fixing condition determining unit 564, and an input-output control unit 567.

The fixing condition determining unit 564 determines a fixing condition of toner for a print sheet from print setting input by the user and the sheet information stored in the sheet information storage unit 565.

The surface effect selection table storage unit 561 stores a surface effect selection table. The gloss-control plane storage unit 562 stores the 8-bit gloss-control plane data received from the si1 unit 52.

The clear-toner plane generating unit 563 uses the gloss-control plane data received from the si1 unit 52 and stored in the gloss-control plane storage unit 562 to generate clear toner plane while referring to the surface effect selection table of the surface effect selection table storage unit 561 and to the fixing condition of the fixing condition determining unit 564. Specifically, the clear-toner plane generating unit 563 determines a surface effect for the density values (pixel values) represented by respective pixels that form the gloss-control plane data. The clear-toner plane generating unit 563 then determines on or off of the glosser 80 according to the determination, and uses the received respective 8-bit color plane data of CMYK to generate an inverse mask or a solid mask as necessary. Thereby, the clear-toner plane generating unit 563 generates 2-bit clear toner plane data as necessary in order to cause the clear toner to adhere. The clear-toner plane generating unit 563 generates the clear toner plane data used in the printer machine 70 and the clear toner plane data used in the low-temperature fixing device 90 as necessary according to the determination result of the surface effect and outputs these data, and outputs the on-off information indicating on or off of the glosser 80.

The inverse mask is used to make uniform the total adhesion amount of the toners of CMYK and the clear toner on pixels that form a target area to which the surface effect is applied. Specifically, all the density values representing pixels that form the target area in the CMYK-plane image data are added, and the image data obtained by subtracting the addition value from a predetermined value is an inverse mask. For example, an inverse mask 1 is expressed by the following Equation (1).

Clr=100−(C+M+Y+K) (1)

where if Clr<0, Clr=0.

In Equation (1), Clr, C, M, Y, and K represent density ratios of a clear toner and respective toners of C, M, Y, and K converted from the density values in pixels. In other words, Equation (1) is used to set a total adhesion amount, in which an adhesion amount of the clear toner is added to the total adhesion amount of the respective toners of C, M, Y, and K, to 100% in all the pixels that form the target area to which the surface effect is applied. When the total adhesion amount of respective toners of C, M, Y, and K is 100% or more, then the clear toner is caused not to adhere and the density ratio is therefore set to 0%. This is because a portion where the total adhesion amount of the respective toners of C, M, Y, and K exceeds 100% is smoothed by fixing processing. In this way, by setting, to 100% or more, the total adhesion amount in all the pixels forming the target area to which the surface effect is applied, surface roughness due to a difference between the total adhesion amounts of toners in the target area is eliminated, and regular reflection of light thereby creates gloss. However, some inverse masks can be obtained by any equation other than Equation (1), and there can be a plurality of types of the inverse mask.

For example, the inverse mask can be those used to uniformly attach the clear toner to each pixel. The inverse mask in this case is also called “solid mask”, and is expressed by the following Equation (2).

Clr=100 (2)

Among the target pixels to which the surface effect is applied, any density ratio other than 100% may be associated with a target pixel, and the solid mask may have a plurality of patterns.

For example, the inverse mask may be obtained by multiplication of background exposure rates of respective colors. The inverse mask in this case is expressed by, for example, the following Equation (3).

Clr=100×{(100−C)/100}×{(100−M)/100}×{(100−Y)/100}×{(100−K)/100} (3)

In Equation (3), (100−C)/100 represents a background exposure rate of C, (100−M)/100 represents a background exposure rate of M, (100−Y)/100 represents a background exposure rate of Y, and (100−K)/100 represents a background exposure rate of K.

For example, the inverse mask may be obtained by using a method based on assumption that halftone dots with a maximum area ratio control the smoothness. The inverse mask in this case is expressed by, for example, the following Equation (4).

Clr=100−max(C,M,Y,K) (4)

In Equation (4), max(C, M, Y, K) indicates that the density value of a color representing the maximum density value of CMYK serves as a representative value.

In other words, those expressed by any one of Equation (1) to Equation (4) can be applied to the inverse mask.

The surface effect selection table stored in the surface effect selection table storage unit 561 will be explained below. The surface effect selection table indicates a correspondence relation between a density value that is a gloss control value representing a surface effect and a type of the surface effect, and also indicates a correspondence relation between these data, control information on a post-processing device according to the configuration of the image forming system, the clear toner plane data used in the printer machine 70, and clear toner plane data used in the post-processing device.

The image forming system can be configured in various ways; however, in the present embodiment, the glosser 80 and the low-temperature fixing device 90 which are the post-processing devices are configured to be connected to the printer machine 70. Therefore, the control information on the post-processing device according to the configuration of the image forming system is the on-off information indicating an or off of the glosser 80. There is the clear toner plane data used in the low-temperature fixing device 90 as the clear toner plane data used in the post-processing device.

FIG. 11 is a diagram of a data structure of the surface effect selection table. The surface effect selection table can be configured so as to indicate a correspondence relation between control information on the post-processing device, image data of a clear toner plane 1 used in the printer machine 70, image data of a clear toner plane 2 used in the post-processing device, a density value, and a type of surface effect. However, FIG. 11 depicts an example of the data structure according to the configuration of the image forming system of the present embodiment. In the correspondence relation between the types of surface effects and the density values illustrated in FIG. 11, each type of the surface effects is associated with each range of density values. Each type of the surface effect is associated with a ratio of density (density ratio) converted from a value as a representative (representative value) in the range of density values in units of 2%. Specifically, the surface effect (specular gloss effect and gloss effect) for applying gloss is associated with a range of density values (“212” to “255”) in which a density ratio is 84% or more. The surface effect (halftone matte and delustered) for suppressing gloss is associated with a range of density values (“1” to “43”) in which a density ratio is 16% or less. The surface effect such as a texture, a background pattern, and a watermark is associated with a range of density values in which a density ratio ranges from 20% to 80%.

The example of the surface effect selection table illustrated in FIG. 11 will be more specifically explained below. The specular gloss (PG: Premium Gloss) as a surface effect is associated with pixel values of, for example, “238” to “255”. Among the pixel values, different types of Premium Gloss are associated with three respective ranges of the pixel values of “238” to “242”, the pixel values of “243” to “247”, and the pixel values of “248” to “255”.

The solid gloss (G: Gloss) is associated with pixel values of “212” to “232”. Among the pixel values, different types of Gloss are associated with four respective ranges of the pixel values of “212” to “216”, the pixel values of “217” to “221”, the pixel values of “222” to “227”, and the pixel values of “228” to “232”.

The halftone matte (M: Matt) is associated with pixel values of “23” to “43”. Among the pixel values, different types of Matt are associated with four respective ranges of the pixel values of “23” to “28”, the pixel values of “29” to “33”, the pixel values of “34” to “38”, and the pixel values of “39” to “43”. The delustered (PM: Premium Matt) is associated with pixel values of “1” to “17”. Among the pixel values, different types of Premium Matt are associated with three respective ranges of the pixel values of “1” to “7”, the pixel values of “8” to “12”, and the pixel values of “13” to “17”. The different types having the same surface effect depend on different equations used to obtain clear toner plane data for use in the printer machine 70 and in the low-temperature fixing device 90, but the operations of the printer body and the post-processing device are the same as each other. “No surface effect” is associated with a density value of “0”.

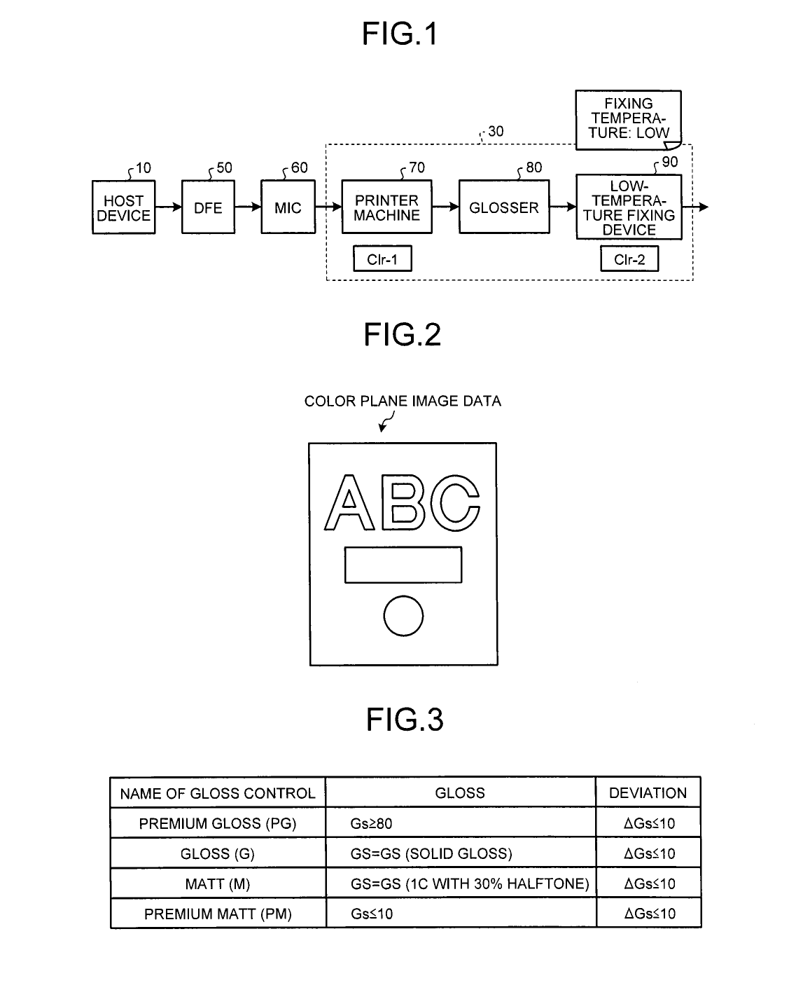

As illustrated in FIG. 11, the contents of the on-off information indicating on or off of the glosser 80, the image data (Clr-1 in FIG. 1) of the clear toner plane 1 used in the printer machine 70, the image data of the clear toner plane 2 used in the low-temperature fixing device 90 are displayed corresponding to the pixel value and the surface effect. For example, when the surface effect is Premium Gloss, it is indicated that the glosser 80 is turned on, the image data of the clear toner plane 1 used in the printer machine 70 represents the inverse mask, and it is indicated that there is no data for the image data of the clear toner plane 2 (Clr-2 in FIG. 1) used in the low-temperature fixing device 90. The inverse mask is obtained by, for example, Equation (1). The example of FIG. 11 represents an example in which the area for which the specular gloss effect is specified as the surface effect corresponds to the whole area defined by the image data. An example in a case in which the area for which the specular gloss effect is specified as the surface effect corresponds to part of the area defined by the image data will be explained later.

When the density value ranges from “228” to “232” and the surface effect is Gloss, it is indicated that the glosser 80 is turned off and that the image data of the clear toner plane 1 used in the printer machine 70 represents the inverse mask 1, and it is indicated that there is no data for the image data of the clear toner plane 2 used in the low-temperature fixing device 90.

Those expressed by any one of Equation (1) to Equation (4) can be applied to the inverse mask 1. This is because the glosser 80 is off and total adhesion amounts of toners to be smoothed are different from each other, and the specular gloss increases the surface roughness, to thereby obtain solid gloss of which glossiness is lower due to the specular gloss. When the surface effect is the halftone matte, it is indicated that the glosser 80 is turned off and that the image data of the clear toner plane 1 used in the printer machine 70 represents Halftone (halftone dots), and it is indicated that there is no data for the image data of the clear toner plane 2 used in the low-temperature fixing device 90. When the surface effect is delustered, it is indicated that the glosser 80 may be turned on or off, and it is indicated that there is no data for the image data of the clear toner plane 1 used in the printer machine 70 and that the image data of the clear toner plane 2 used in the low-temperature fixing device 90 represents a solid mask. The solid mask is obtained by, for example, Equation (2).

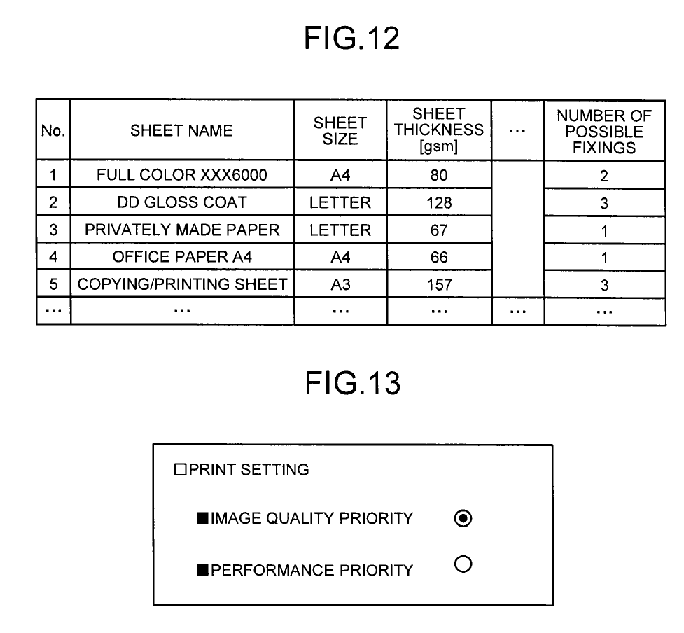

Referring back to FIG. 10, the sheet information storage unit 565 stores information for sheets as a sheet list. FIG. 12 is a diagram of an example of the sheet list. As illustrated in FIG. 12, sheet information such as “Sheet Name”, “Sheet Size”, “Sheet Thickness”, and “Number of Possible Fixings” is registered in the sheet list. “Number of Possible Fixings” is the number of times indicating that toner can be fixed on a sheet a plurality of times.

Referring back to FIG. 10, the input-output control unit 567 performs display control on various screens such as an input screen of print setting for the display unit 59 and input control on various specifications such as print setting through the input screen of the print setting from the input unit 58. FIG. 13 is a diagram of an example of the input screen of print setting.

As illustrated in FIG. 13, the input screen of the print setting displays “Image quality priority” and “Performance priority” as priority items in printing so that the user can select either one of them. In addition, the input screen of the print setting may be configured so that the user can select a print setting for each sheet, and the input-output control unit 567 may be configured so that the set contents set in the input screen of the print setting are stored as attribute information in the sheet list illustrated in FIG. 12.

The clear-toner plane generating unit 563 of the clear processing 56 refers to the surface effect selection table in the above manner to determine which surface effect is associated with each pixel value indicated by the gloss-control plane data, determines whether the glosser 80 is on or off, and determines which clear toner plane data is to be used in the printer machine 70 and in the low-temperature fixing device 90. The clear-toner plane generating unit 563 determines whether the glosser 80 is on or off for each page. The clear-toner plane generating unit 563 then generates clear toner plane data as necessary according to the result of determination and outputs the clear toner plane data, and outputs the on-off information for the glosser 80. Therefore, the clear toner plane data with gloss effect intended by the user is generated.

Referring back to FIG. 10, the si3 unit 57 integrates respective 2-bit image data of CMYK after the halftone processing and the 2-bit clear toner plane data generated by the clear processing 56, and outputs the integrated image data to the MIC 60. The clear processing 56 may not generate at least either one of the clear toner plane data used in the printer machine 70 and the clear toner plane data used in the low-temperature fixing device 90. Therefore, when the clear toner plane data generated by the clear processing 56 is integrated by the si3 unit 57 and both of the clear toner plane data are not generated by the clear processing 56, image data in which respective 2-bit image data of CMYK are integrated is output from the si3 unit 57. Accordingly, four to six pieces of respective 2-bit image data are output from the DFE 50 to the MIC 60. The si3 unit 57 outputs the on-off information for the glosser 80 output by the clear processing 56 to the MIC 60.

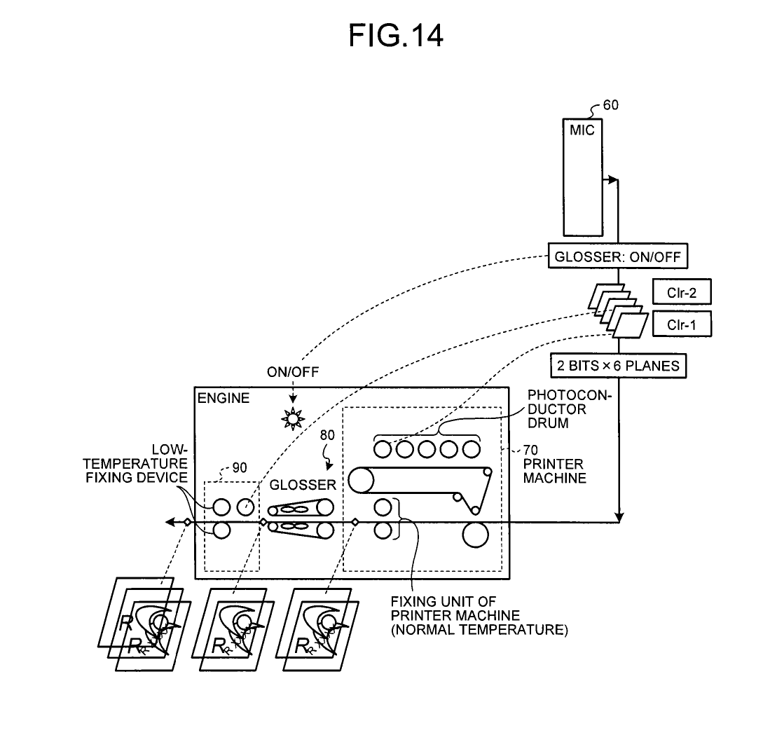

The MIC 60 is connected to the DFE 50 and to the printer machine 70. The MIC 60 outputs device configuration information indicating a device configuration mounted as a post-processing device to the DFE 50. The MIC 60 receives the color plane image data and the clear toner plane image data from the DFE 50, allocates the image data to corresponding devices, and controls the post-processing devices. More specifically, as illustrated in FIG. 14, the MIC 60 outputs color plane image data of CMYK among the image data output from the DFE 50 to the printer machine 70. When the clear toner plane image data used in the printer machine 70 is included therein, the MIC 60 also outputs this image data to the printer machine 70, and uses the on-off information output from the DFE 50 to turn on or off the glosser 80. When the clear toner plane image data used in the low-temperature fixing device 90 is included therein, the MIC 60 outputs this image data to the low-temperature fixing device 90. The glosser 80 may switch between a path for performing fixing and a path for not performing fixing by using the on-off information. The low-temperature fixing device 90 may perform on/off switching or the path switching similar to the glosser 80, depending on the presence or absence of the clear toner plane image data.

As illustrated in FIG. 14, the printing device 30 formed from the printer machine 70, the glosser 80, and the low-temperature fixing device 90 includes a conveying path for conveying a recording medium. Specifically, the printer machine 70 includes a plurality of electrophotographic photoconductor drums, a transfer belt to which a toner image formed on each of the photoconductor drums is transferred, a transfer device that transfers the toner images on the transfer belt to a recording medium, and a fixing unit that fixes the toner images on the recording medium thereon. The recording medium is conveyed along the conveying path by a conveying member (not illustrated), so that it is conveyed through locations where the printer machine 70, the glosser 80, and the low-temperature fixing device 90 are provided, in this order. The processings are sequentially performed on the recording medium by these devices, and after image formation and surface effect are applied thereto, the recording medium is conveyed along the conveying path by a conveying mechanism (not illustrated), and is ejected to the outside of the printing device.

Therefore, when the image data output from the DFE 50 includes the color plane data of CMYK and the clear toner plane data, a color image specified by the color plane data is formed on the recording medium using the color toner, a surface effect of a type specified by the clear toner plane data is applied to the recording medium using the clear toner, and a transparent image specified by the clear toner plane data is formed on the recording medium using the clear toner. In other words, the surface effect based on the clear toner plane data having the gloss effect as the effect intended by the user is applied to the recording medium according to a sheet type.

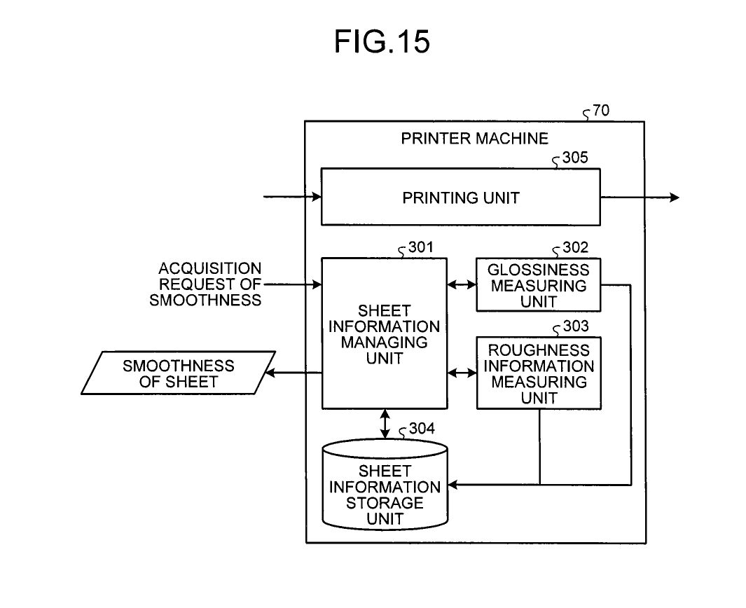

A functional configuration of the printer machine 70 will be explained next. FIG. 15 is a block diagram of the functional configuration of the printer machine 70 according to the present embodiment. As illustrated in FIG. 15, the printer machine 70 according to the present embodiment includes a sheet information managing unit 301, a glossiness measuring unit 302, a roughness information measuring unit 303, a sheet information storage unit 304, and a printing unit 305.

The printing unit 305 is an engine for printing image data on a sheet.

The sheet information storage unit 304 stores a sheet type of a current sheet to be printed. The sheet information storage unit 304 also stores a glossiness of the sheet measured by the glossiness measuring unit 302 and roughness information (smoothness) of the sheet measured by the roughness information measuring unit 303. The type of the sheet, the glossiness of the sheet, and the roughness information of the sheet form the sheet information. The sheet information storage unit 304 is a storage medium such as a hard disk drive (HDD) or a memory.

The glossiness measuring unit 302 receives a measurement instruction from the sheet information managing unit 301, measures a glossiness of sheets stored in a tray or so, and stores the measured glossiness in the sheet information storage unit 304. The roughness information measuring unit 303 receives a measurement instruction from the sheet information managing unit 301, measures a smoothness of sheets stored in the tray or so, and stores the measured smoothness as sheet roughness information in the sheet information storage unit 304. A known method is used as a method of measuring a glossiness of sheets and a method of measuring a smoothness thereof.

The sheet information managing unit 301 manages the sheet information stored in the sheet information storage unit 304. More specifically, when receiving an acquisition request of smoothness from the DFE 50 via the MIC 60, the sheet information managing unit 301 transmits the smoothness of the current sheet to be printed stored in the sheet information storage unit 304 to the DFE 50 via the MIC 60.

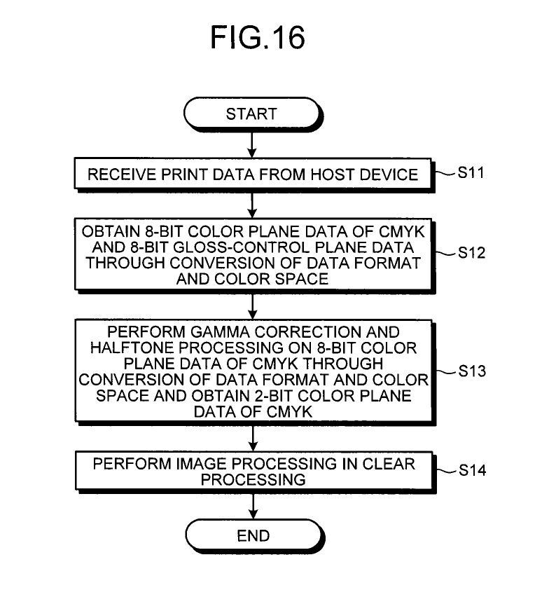

A procedure of gloss control processing performed by the image forming system according to the present embodiment will be explained next with reference to FIG. 16. When the DFE 50 receives the print data from the host device 10 (Step S11), the rendering engine 51 interprets the language of the received image data, converts the image data expressed in the vector format into image data in the raster format, and converts a color space expressed in the RGB format into a color space in the CMYK format to obtain respective 8-bit color plane data of CMYK and 8-bit gloss-control plane data (Step S12). As explained later, there is a case in which no gloss-control plane data is included in the print data. In this case, the processing at Step S12 is not performed.

In the conversion processing of the gloss-control plane data, the gloss-control plane data of FIG. 4, that is, the gloss-control plane data, as illustrated in FIG. 7, in which a density value for identifying a surface effect is specified for each drawing object is converted into the gloss-control plane data in which the density value is specified for each of pixels that form the drawing object.

In other words, the rendering engine 51 gives a density value set for the drawing object to pixels in a coordinate range corresponding to the drawing object of the gloss-control plane data illustrated in FIG. 7 and thereby performs conversion of the gloss-control plane data. The gloss-control plane data is thereby converted to the gloss-control plane data in which a surface effect is set in each pixel.

When the 8-bit gloss-control plane data is output, the TRC 53 of the DFE 50 performs gamma correction on respective 8-bit color plane data of CMYK by using a gamma curve of the 1D_LUT generated by calibration, and outputs the respective 8-bit color plane data of CMYK after the gamma correction to the halftone engine 55 and to the clear processing 56 via the sit unit 54. The halftone engine 55 performs halftone processing, for converting the image data into a data format of respective 2-bit color plane data of CMYK in order to output the converted data to the printer machine 70, on the gamma-corrected image data, and obtains respective 2-bit color plane data of CMYK after the halftone processing (Step S13).

The clear processing 56 of the DFE 50 then performs image processing (Step S14).

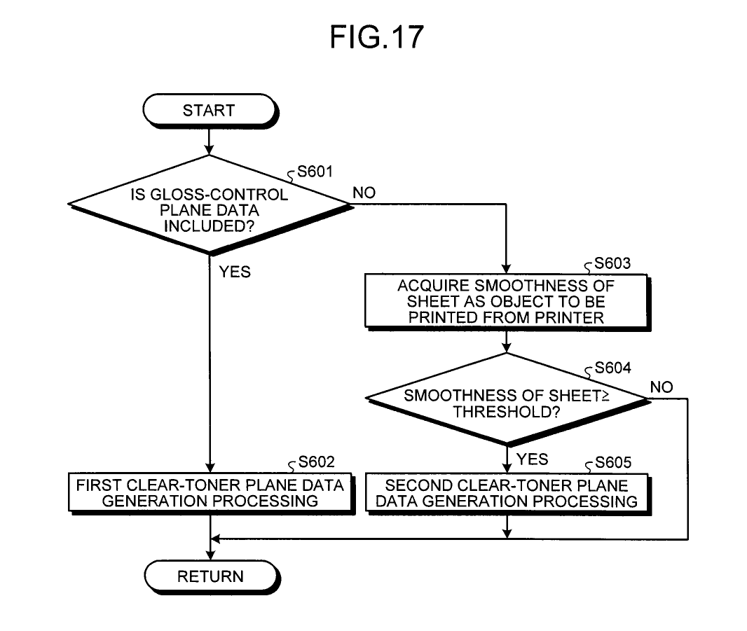

Details of the image processing performed by the clear processing 56 at Step S14 will be explained next. FIG. 17 is a flowchart of a procedure of the image processing performed by the clear processing 56.

First of all, the clear processing 56 checks whether the gloss-control plane data is included in the received image data (print data) (Step S601). Then, when the gloss-control plane data is included in the image data (Yes at Step S601), the clear-toner plane generating unit 563 performs first clear-toner plane data generation processing for generating clear toner plane data in order to apply the surface effect to the sheet (Step S602). The details of the first clear-toner plane data generation processing will be explained later.

At Step S601, when the gloss-control plane data is not included in the image data (No at Step S601), the clear-toner plane generating unit 563 transmits an acquisition request of a smoothness of the sheet as an object to be printed to the printer machine 70 and acquires the smoothness of the sheet to be printed from the printer machine 70 (Step S603).

The clear-toner plane generating unit 563 previously stores a threshold used to determine whether the sheet has large surface roughness. When the smoothness is the threshold or higher, then it is determined that the sheet has large surface roughness. The clear-toner plane generating unit 563 determines whether the smoothness acquired at Step S601 is the threshold or higher (Step S604). When the smoothness of the sheet is the threshold or higher (Yes at Step S604), that is, when the sheet has large surface roughness, the clear-toner plane generating unit 563 performs second clear-toner plane data generation processing for generating clear toner plane data in order to smooth the sheet surface (Step S605). The details of the second clear-toner plane data generation processing will be explained later.

Meanwhile, when the smoothness of the sheet acquired at Step S603 is lower than the threshold (No at Step S604), that is, when the sheet has small surface roughness, then the clear-toner plane generating unit 563 ends the processing.

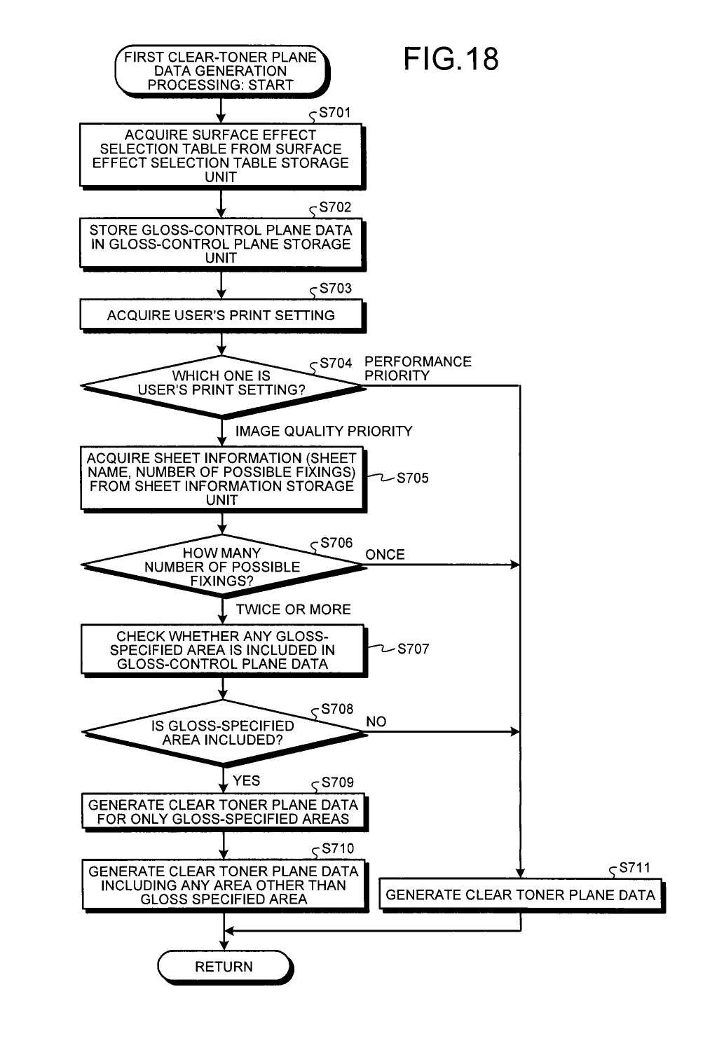

The details of the first clear-toner plane data generation processing at Step S602 will be explained next. The first clear-toner plane data generation processing is processing for generating clear toner plane data in order to apply a surface effect such as the specular gloss to the sheet. FIG. 18 is a flowchart of a procedure of the first clear-toner plane data generation processing.

The clear-toner plane generating unit 563 acquires the surface effect selection table from the surface effect selection table storage unit 561 (Step S701). The clear-toner plane generating unit 563 stores the received gloss-control plane data in the gloss-control plane storage unit 562 (Step S702).

The fixing condition determining unit 564 acquires user's print setting (“Image quality priority” or “Performance priority”) from the input-output control unit 567 (Step S703), and determines the user's print setting (Step S704). When the user's print setting is “Image quality priority”, then the fixing condition determining unit 564 acquires sheet information (Sheet Name, Number of Possible Fixings) for the print sheet from the sheet list in the sheet information storage unit 565 (Step S705).

The fixing condition determining unit 564 then determines the number of possible fixings (Step S706). When the number of possible fixings of the sheet is “Twice or more”, then the fixing condition determining unit 564 notifies the clear-toner plane generating unit 563 of the determination result (number of fixings: Twice or more). When receiving the notification from the fixing condition determining unit 564, then the clear-toner plane generating unit 563 checks whether any gloss-specified area is included in the gloss-control plane data (Step S707).

In the gloss-control plane data, areas in which density values (238 to 255, density (%)=94%, 96%, 98%) corresponding to “Premium Gloss Types A to C” (Glosser ON/OFF (on-off information) is “ON”) are set in the surface effect selection table acquired at Step S701 are gloss-specified areas. Therefore, when an area in which the density value is set is included in the gloss-control plane data, the clear-toner plane generating unit 563 determines that the gloss-specified area is included in the gloss-control plane data.

When the gloss-specified area is included in the gloss-control plane data (Yes at Step S708), at first, the clear-toner plane generating unit 563 generates clear toner plane data for only the gloss-specified areas in which the density values corresponding to the “Premium Gloss Types A to C” are set (Step S709). The generated clear toner plane data is used to form only a clear toner image in the gloss-specified area. Thereafter, the clear-toner plane generating unit 563 generates clear toner plane data including the gloss-specified area and any area other than the gloss specified area (Step S710). The generated clear toner plane data is used to form a normal toner image in all the area of the sheet.

The reason why the clear-toner plane generating unit 563 generates the two clear toner plane data: the clear toner plane data only for the gloss-specified area at Step S709 and the clear toner plane data including the area other than the gloss-specified area at Step S710 is because of the following reasons.

To apply the surface effect as specular gloss to the sheet by the gloss processing, the sheet surface needs to be smooth. The printer machine 70 can form a clear toner image for absorbing the roughness in an area on the sheet where gloss is expected to be applied at first fixing, from the clear toner plane data only for the gloss-specified area generated at Step S709. The printer machine 70 then forms a clear toner image in the area on the sheet of which roughness is absorbed in the above manner and surface is thereby smoothed and to which the gloss is expected to be applied, from the clear toner plane data including both the gloss-specified area and the area other than the gloss-specified area which are generated at Step S710. Therefore, it is possible to improve the glossiness of the specular gloss by the gloss processing and to thereby apply the surface effect as specular gloss to the sheet.

In other words, the first embodiment is configured to fix only a clear toner in first printing on a specified area to which the surface effect for increasing glossiness as gloss is applied, to absorb the surface roughness of the sheet, and then to fix a clear toner and a color toner in second and subsequent printings. Therefore, the glossiness is increased even if the sheet has large surface roughness. This type of printing is called N-pass printing.

Referring back to Step S704, when the user's print setting is “Performance priority”, or when the number of possible fixings of the sheet is “Once” at Step S706, then the fixing condition determining unit 564 notifies the clear-toner plane generating unit 563 of the determination result (number of fixings: Once).

When receiving the notification from the fixing condition determining unit 564, then the clear-toner plane generating unit 563 generates clear toner plane data from the gloss-control plane data and the color plane data (Step S711). In other words, the clear-toner plane generating unit 563 generates single clear toner plane data instead of generating the two pieces of clear toner plane data as illustrated at Steps S709 and S710. The generated clear toner plane data is used to form a normal toner image in all the area of the sheet.

At Step S708, even if no gloss-specified area is included in the gloss-control plane data (No at Step S708), the clear-toner plane generating unit 563 generates single clear toner plane data from the gloss-control plane data and the color plane data (Step S711).

After the generation of the clear toner plane data, the si3 unit 57 transmits the clear toner plane data generated at Step S709, S710, or S711 and the information for specification of a plurality of fixings (“ON” or “OFF”) which is information as to whether a plurality of fixings is performed, to the printer machine 70 via the MIC 60.

Here, when the user's print setting is “Image quality priority” and the number of possible fixings of the print sheet is “Twice or more”, then the si3 unit 57 sets the specification of a plurality of fixings to “ON”. When the user's print setting is “Performance priority” or when the user's print setting is “Image quality priority” and the number of possible fixings of the print sheet is “Once”, then the si3 unit 57 sets the specification of a plurality of fixings to “OFF”.

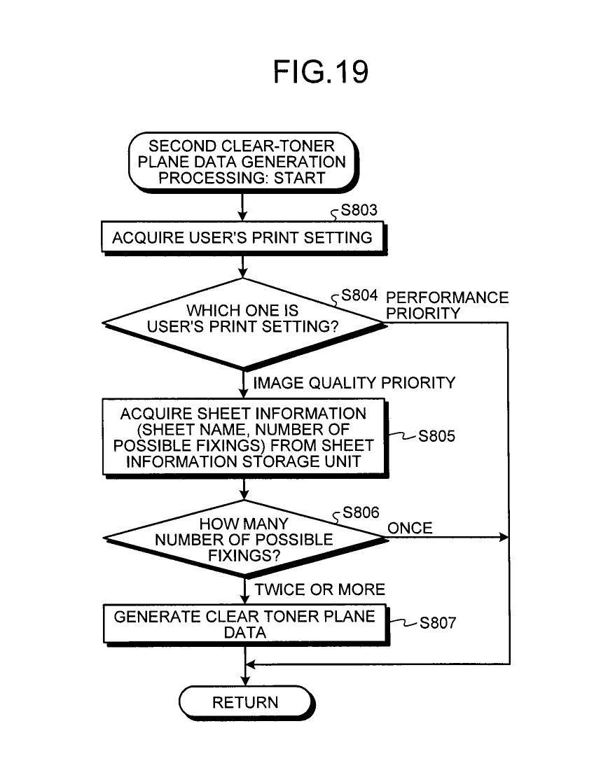

The details of the second clear-toner plane data generation processing at Step S605 will be explained next. The second clear-toner plane data generation processing is processing for generating clear toner plane data in order to smooth a sheet. FIG. 19 is a flowchart of a procedure of the second clear-toner plane data generation processing.

First of all, the fixing condition determining unit 564 acquires user's print setting from the input-output control unit 567 (Step S803), and determines the acquired user's print setting (Step S804). When the user's print setting is “Image quality priority”, then the fixing condition determining unit 564 acquires the sheet information (Sheet Name, Number of Possible Fixings) for the print sheet from the sheet list in the sheet information storage unit 565 (Step S805).

The fixing condition determining unit 564 then determines the number of possible fixings acquired at Step S805 (Step S806). When the number of possible fixings of the sheet is “Twice or more”, then the fixing condition determining unit 564 notifies the clear-toner plane generating unit 563 of the determination result (number of fixings: Twice or more).

When receiving the notification from the fixing condition determining unit 564, then the clear-toner plane generating unit 563 generates clear toner plane data (Step S807). The generated clear toner plane data is used to absorb the sheet roughness at the first fixing, as explained later.

At Step S804, when the user's print setting is “Performance priority”, the processing is ended without performing the processings from Steps S805 to S807. When the number of possible fixings is “Once” at Step S806, then the processing is ended without performing the processing at Step S807.

After the generation of the clear toner plane data, the si3 unit 57 transmits the clear toner plane data generated at Step S807 and the information for specification of a plurality of fixings (“ON” or “OFF”) being information as to whether a plurality of fixings is performed to the printer machine 70 via the MIC 60.

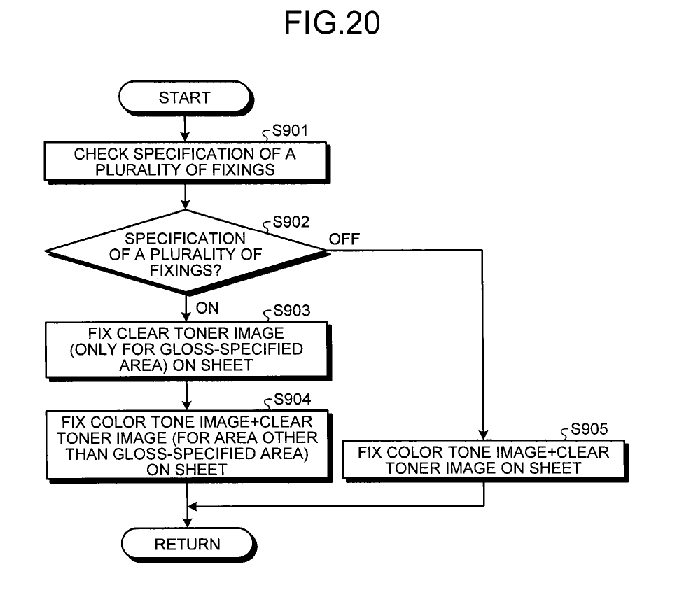

The print processing performed by the printer machine 70 will be explained next. The print processing for the case where clear toner plane data for applying a surface effect is generated through the first clear-toner plane data generation processing will be explained first. FIG. 20 is a flowchart of a procedure of print processing for the case where clear toner plane data for applying the surface effect is generated.

The printing unit 305 of the printer machine 70 checks the information for specification of a plurality of fixings received from the DFE 50 (Step S901). When the specification of a plurality of fixings is “ON” (ON at Step S902), the printing unit 305 first generates only a clear toner image from the clear toner plane data for only the gloss-specified area that is generated at Step S709 in the first clear-toner plane data generation processing, and fixes the generated clear toner image on the print sheet (Step S903). By performing the processing, the sheet surface roughness in the area on which gloss processing is performed is absorbed, thus improving the glossiness of the specular gloss through the gloss processing.

The printing unit 305 then forms a toner image based on the color plane data and the clear toner plane data for the area other than the gloss-specified area that is generated at Step S710 in the first clear-toner plane data generation processing, and fixes the formed toner image on the print sheet (Step S904).

Referring back to Step S902, when the specification of a plurality of fixings is “OFF” (OFF at Step S902), the printing unit 305 forms a toner image from the color plane data and the clear toner plane data generated at Step S711 in the first clear-toner plane data generation processing without absorbing the sheet roughness as illustrated at Step S903, and fixes the formed toner image on the print sheet (Step S905).

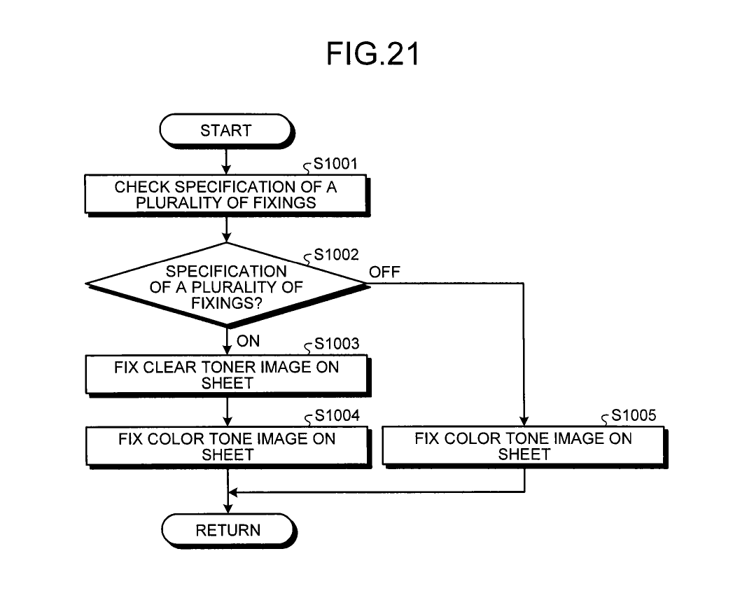

The print processing for the case where clear toner plane data for smoothing the sheet surface is generated through the second clear-toner plane data generation processing will be explained next. FIG. 21 is a flowchart of a procedure of print processing when clear toner plane data for smoothing the sheet surface is generated.

The printing unit 305 of the printer machine 70 checks the information for specification of a plurality of fixings from the DFE 50 (Step S1001). When the specification of a plurality of fixings is “ON” (ON at Step S1002), the printing unit 305 first generates a clear toner image from the clear toner plane data generated at Step S807 in the second clear-toner plane data generation processing, and fixes the generated clear toner image on the print sheet (Step S1003). By performing the processing, the sheet surface can be smoothed.

The printing unit 305 then fixes the toner image formed from the color plane data on the print sheet (Step S1004).

Referring back to Step S1002, when the specification of a plurality of fixings is “OFF” (OFF at Step S1002), the printing unit 305 fixes only the toner image formed from the color plane data on the print sheet (Step S1005).

In this way, the present embodiment is configured to perform the N-pass printing, that is, to fix only a clear toner in the first printing on a specified area to which the surface effect for increasing glossiness as gloss is applied, to absorb the surface roughness of the sheet, and then to fix a clear toner and a color toner in the second and subsequent printings. Therefore even if the sheet has large surface roughness, the glossiness is increased and the surface effect intended by the user can be obtained. Moreover, in the present embodiment, even if there is no specified area to which the surface effect for increasing the glossiness is applied, the surface roughness of the sheet can be smoothed if the sheet has large surface roughness.

The first embodiment is configured to fix only a clear toner in the first printing on a specified area of the sheet to which the surface effect for increasing glossiness as gloss is applied, to absorb the surface roughness of the sheet, and then to fix a clear toner and a color toner in the second and subsequent printings. Therefore even if the sheet has large surface roughness, the glossiness is increased and the surface effect intended by the user can be obtained. However, in the N-pass printing upon warming up such as when the printer machine 70 is powered on or when it returns from energy-saving mode, when the printer does not reach a fixing possible temperature of a color toner even if a fixing device such as the low-temperature fixing device 90 reaches a fixing possible temperature of a clear toner, the printing is not started until it reaches the fixing possible temperature of the color toner, thus it takes time to print. As a result of taking time to print, power consumption is increased.

In a second embodiment, therefore, in the N-pass printing upon warming up, the clear toner is fixed in the first printing on the area to which the surface effect for increasing glossiness is applied at the time when the fixing device such as the low-temperature fixing device 90 reaches the fixing possible temperature of the clear toner. Thereby reduction of the entire printing time is achieved and the power consumption required for the print processing is reduced.

The configuration of the image forming system according to the present embodiment, the configuration of the host device 10, and the configuration of the printing device 30 are the same as these of the first embodiment. The printing device 30 includes the low-temperature fixing device 90 as the fixing device; however, any fixing device other than the fixing device can be used. The fixing device such as the low-temperature fixing device 90 is hereinafter collectively called the “fixing device”.

The gloss-control plane data, the color plane data, the clear plane data, and the print data (image data) according to the present embodiment are the same as these of the first embodiment.

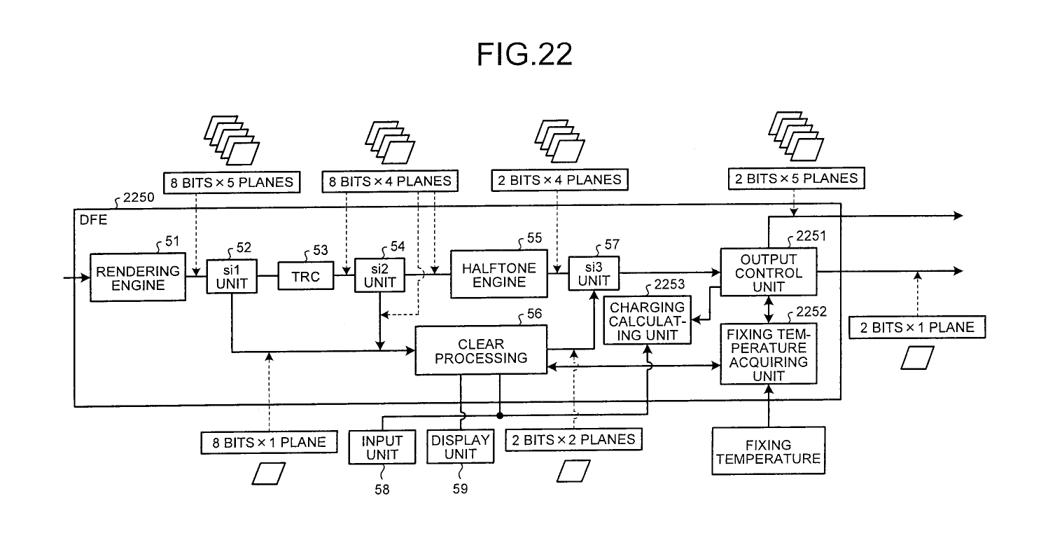

FIG. 22 is a block diagram of a functional configuration of a DFE 2250 according to the second embodiment. As exemplified in FIG. 22, the DFE 2250 according to the second embodiment includes the rendering engine 51, the si1 unit 52, the TRC 53, the si2 unit 54, the halftone engine 55, the clear processing 56, the si3 unit 57, the input unit 58, the display unit 59, an output control unit 2251, a fixing temperature acquiring unit 2252, and a charging calculating unit 2253. Each of the rendering engine 51, the si1 unit 52, the TRC 53, the si2 unit 54, the halftone engine 55, the clear processing 56, the si3 unit 57, the input unit 58, and the display unit 59 has the same configuration as that of the first embodiment. The present embodiment assumes that the gloss-control plane data is included in the print data.

The rendering engine 51, the si1 unit 52, the TRC 53, the si2 unit 54, the halftone engine 55, the clear processing 56, the si3 unit 57, the output control unit 2251, the fixing temperature acquiring unit 2252, and the charging calculating unit 2253 are implemented by causing a control unit of the DFE 2250 to execute various programs stored in the main storage unit or in the auxiliary storage unit.

The configuration of the clear processing 56 is the same as that of the first embodiment, but a function of the fixing condition determining unit 564 is added to the function according to the first embodiment. Similarly to the first embodiment, the fixing condition determining unit 564 according to the present embodiment determines the fixing condition of toner for a print sheet from the print setting input by the user and the sheet information stored in the sheet information storage unit 565, and further determines whether a fixing temperature acquired from the fixing device by the fixing temperature acquiring unit 2252 is a fixing temperature of a clear toner or higher. The fixing possible temperature of the clear toner is previously determined based on characteristics of the clear toner, and the like.

The fixing condition determining unit 564 also determines whether the fixing temperature acquired from the fixing device by the fixing temperature acquiring unit 2252 is a fixing temperature of a color toner or higher, according to an instruction from the output control unit 2251. The fixing temperature of the color toner is previously determined based on characteristics of the color toner, and the like. The fixing condition determining unit 564 outputs determination results as to whether the fixing temperature is the fixing temperature of the clear toner or higher and as to whether the fixing temperature is the fixing temperature of the color toner or higher to the output control unit 2251.

The si3 unit 57 according to the present embodiment acquires the clear toner plane data only for the gloss-specified area generated at Step S709 in FIG. 18 by the clear-toner plane generating unit 563 of the clear processing 56 and the clear toner plane data including the area other than the gloss-specified area generated at Step S710 in FIG. 18 by the clear-toner plane generating unit 563 from the clear processing 56. The si3 unit 57 then outputs the acquired two clear toner plane data to the output control unit 2251. The si3 unit 57 acquires the information for specification of a plurality of fixings (“ON” or “OFF”) from the clear processing 56, and outputs the acquired information for specification of a plurality of fixings to the output control unit 2251.

The fixing temperature acquiring unit 2252 receives an instruction from the output control unit 2251 to acquire a fixing temperature of the fixing device from the fixing device.

The output control unit 2251 controls the output of the clear toner plane data received from the si3 unit 57 to the printer machine 70 via the MIC 60 based on the fixing temperature of the fixing device acquired by the fixing temperature acquiring unit 2252.

Specifically, when the information for specification of a plurality of fixings acquired from the si3 unit 57 indicates that a plurality of fixings is possible and when the determination result acquired from the fixing condition determining unit 564 indicates that the fixing temperature is the fixing temperature of the clear toner or higher, the output control unit 2251 outputs the clear toner plane data only for the gloss-specified area, of the clear toner plane data received from the si3 unit 57, to the printer machine 70 via the MIC 60. The clear toner plane data only for the gloss-specified area is used to fix only the clear toner on the area of the sheet to which the surface effect for increasing glossiness is applied in the first printing.

Furthermore, when the determination result acquired from the fixing condition determining unit 564 indicates that the fixing temperature is the fixing temperature of the color toner or higher, the output control unit 2251 outputs the clear toner plane data including the area other than the gloss-specified area to the printer machine 70 via the MIC 60. The clear toner plane data including the area other than the gloss-specified area is used to fix the color toner in second and subsequent printings.

The charging calculating unit 2253 performs charging count processing on the printing using the clear toner plane data output to the output control unit 2251 according to an instruction from the output control unit 2251, based on charge setting information received from the input unit 58.

The input unit 58 is an input device such as a keyboard and a mouse. The input unit 58 receives an input for each setting (print setting, charge setting, start/cancel of printing) from the user. The display unit 59 is a display device such as a display. The display unit 59 performs a display of each setting (print setting, charge setting, and instruction to set the sheet output in the first printing) to the user.

The output control processing according to the present embodiment configured in the above manner will be explained next. In the present embodiment, the gloss control processing is performed in the same manner as that of the first embodiment explained with reference to FIG. 16. The clear-toner plane data generation processing performed by the clear processing 56 is performed in the same manner as that of the first embodiment explained with reference to FIG. 17; however, in the present embodiment, the gloss-control plane data is included in the print data. Therefore, it is determined as Yes at Step S601, and the first clear-toner plane data generation processing illustrated in FIG. 18 is executed. In other words, the second clear-toner plane data generation processing illustrated in FIG. 19 executed when the gloss-control plane data is not included in the print data is not executed in the present embodiment.

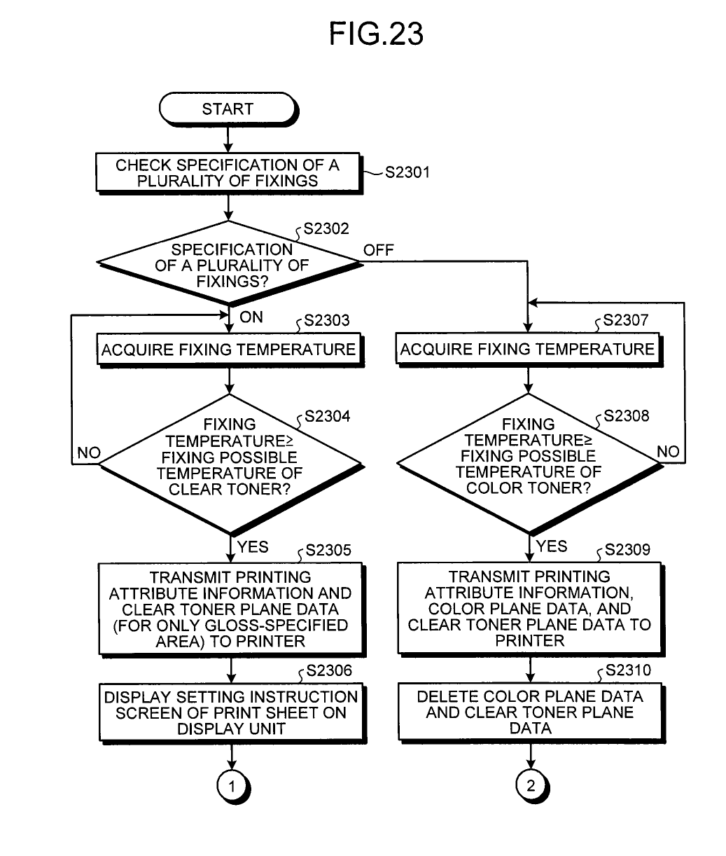

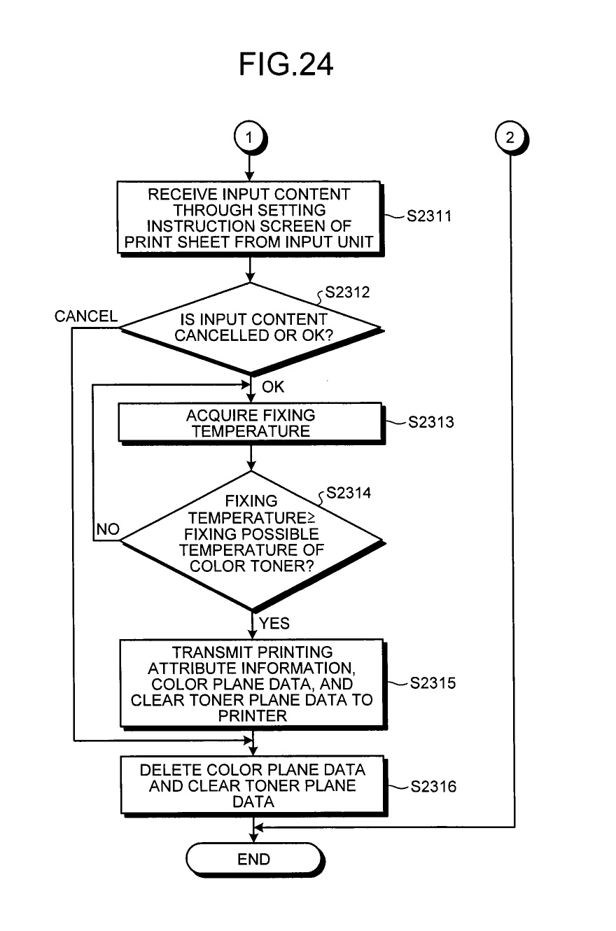

FIG. 23 and FIG. 24 are flowcharts of a procedure of the output control processing according to the second embodiment. First of all, the output control unit 2251 checks the information for specification of a plurality of fixings acquired from the clear processing 56 and the si3 unit 57 (Step S2301). The output control unit 2251 then determines the information for specification of a plurality of fixings (Step S2302). When the specification of a plurality of fixings is ON, the output control unit 2251 instructs the fixing temperature acquiring unit 2252 to acquire a fixing temperature of the fixing device (Step S2303). The fixing temperature acquiring unit 2252 outputs the acquired fixing temperature to the fixing condition determining unit 564 of the clear processing 56.

The fixing condition determining unit 564 determines whether the acquired fixing temperature is a previously determined fixing possible temperature of clear toner or higher (Step S2304). When the fixing temperature is lower than the previously determined fixing possible temperature of clear toner (No at Step S2304), then the fixing condition determining unit 564 repeats the processing at Step S2303.

Meanwhile, at Step S2304, when the fixing temperature is the previously determined fixing possible temperature of clear toner or higher (Yes at Step S2304), then the output control unit 2251 outputs the printing attribute information and the clear toner plane data for only the gloss-specified areas to the printing device 30 via the MIC 60 (Step S2305). The first printing is thereby performed by the printing device 30, a clear toner image is formed in the gloss-specified area of the sheet, and the roughness in the gloss-specified area is smoothed.

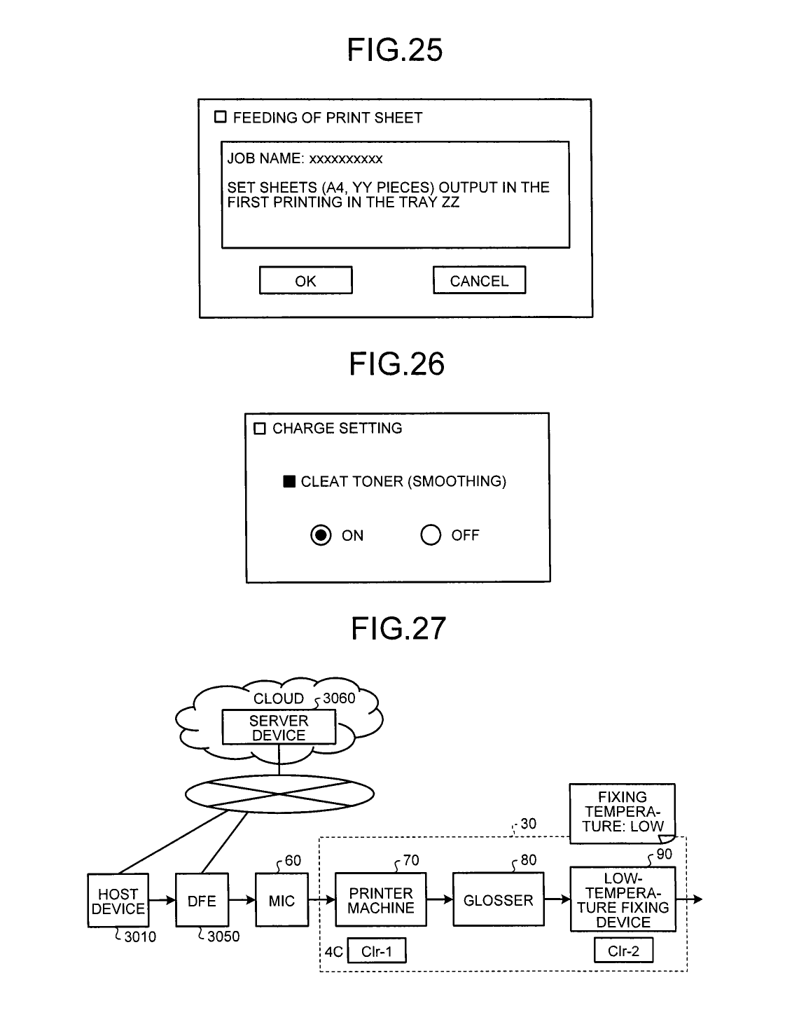

The output control unit 2251 then displays a setting instruction screen for a print sheet on the display unit 59 (Step S2306). FIG. 25 is a diagram of an example of a setting instruction screen for a print sheet according to the second embodiment. As illustrated in FIG. 25, the setting instruction screen for the print sheet displays a message prompting for the user to set the sheet that is output in the first printing using the clear toner in a tray, and the user presses either one of OK button and Cancel button, thus enabling an input.

The output control unit 2251 receives a user's input content through the setting instruction screen for a print sheet via the input unit 58 (Step S2311), and determines whether the input content is cancelled or OK (Step S2312). When the input content is cancelled, the process proceeds to Step S2316, and the output control unit 2251 deletes the two clear toner plane data and color plane data (Step S2316).

Meanwhile, at Step S2312, when the input content is OK, then the output control unit 2251 instructs the fixing temperature acquiring unit 2252 to acquire a fixing temperature of the fixing device (Step S2313). The fixing temperature acquiring unit 2252 outputs the acquired fixing temperature to the fixing condition determining unit 564 of the clear processing 56.

The fixing condition determining unit 564 determines whether the acquired fixing temperature is a previously determined fixing possible temperature of color toner or higher (Step S2314). When the fixing temperature is lower than the previously determined fixing possible temperature of color toner (No at Step S2314), then the fixing condition determining unit 564 repeats the processing at Step S2313.

Meanwhile, at Step S2314, when the fixing temperature is the previously determined fixing possible temperature of color toner or higher (Yes at Step S2314), then the output control unit 2251 outputs the printing attribute information, the clear toner plane data including the area other than the gloss-specified area, and the color plane data to the printing device 30 via the MIC 60 (Step S2315). The second printing is thereby performed on the sheet, and the toner image is formed thereon.

The output control unit 2251 then deletes the two clear toner plane data and color plane data (Step S2316), and the processing is ended.

Referring back to Step S2302, when the specification of a plurality of fixings is OFF, the output control unit 2251 instructs the fixing temperature acquiring unit 2252 to acquire a fixing temperature of the fixing device (Step S2307). The fixing temperature acquiring unit 2252 outputs the acquired fixing temperature to the fixing condition determining unit 564 of the clear processing 56.

The fixing condition determining unit 564 determines whether the acquired fixing temperature is a previously determined fixing possible temperature of color toner or higher (Step S2308). When the fixing temperature is lower than the previously determined fixing possible temperature of color toner (No at Step S2308), then the fixing condition determining unit 564 repeats the processing at Step S2307.

Meanwhile, at Step S2308, when the fixing temperature is the previously determined fixing possible temperature of color toner or higher (Yes at Step S2308), then the output control unit 2251 outputs the printing attribute information, the clear toner plane data including the area other than the gloss-specified area, and the color plane data to the printing device 30 via the MIC 60 (Step S2309). The toner image is thereby formed on the sheet.

The output control unit 2251 then deletes the clear toner plane data and the color plane data (Step S2310), and the processing is ended.

The print processing executed by the printer machine 70 that receives the two clear toner plane data and color plane data is performed in the same manner as that of the first embodiment explained with reference to FIG. 20.

The charging processing according to the present embodiment will be explained next. FIG. 26 is a diagram of an example of a charge setting screen according to the second embodiment. The charging calculating unit 2253 displays the charge setting screen of FIG. 26 on the display unit 59 due to initial setting or the like. The user can select either one of “ON” and “OFF” as charge setting for clear toner (smoothing) through the charge setting screen, and the input unit 58 receives the selection. When “ON” is selected on the charge setting screen, the charging calculating unit 2253 can include formation of a clear toner image used for absorbing the surface roughness of the sheet upon printing, that is, formation of a clear toner image based on the clear toner plane data only for the gloss-specified area performed at Step S2305 in a charging object.

In this way, according to the present embodiment, in the N-pass printing upon warming up, when the fixing device such as the low-temperature fixing device 90 reaches a fixing possible temperature of a clear toner, the clear toner is fixed, in the first printing, on the area to which the surface effect for increasing glossiness is applied. Therefore, reduction of the entire printing time can be achieved and the power consumption required for the print processing can be reduced.

The first embodiment is configured to provide the clear processing 56 in the DFE 50 and perform the clear-toner plane data generation processing in the DFE 50; however, the embodiment is not limited thereto.

In other words, it may be configured that any one of a plurality of processings performed by one device is performed by one or any other devices connected to the one device via a network.

As an example thereof, in an image forming system according to a third embodiment, part of the functions of the DFE is implemented in a server device on the network.

FIG. 27 is a diagram of a configuration of the image forming system according to the third embodiment. As illustrated in FIG. 27, the image forming system according to the present embodiment includes a host device 3010, a DFE 3050, the MIC 60, the printer machine 70, the glosser 80, the low-temperature fixing device 90, and a server device 3060 provided in a cloud. The post-processing devices such as the glosser 80 and the low-temperature fixing device 90 are not limited thereto.

The present embodiment is configured that the host device 3010 and the DFE 3050 are connected to the server device 3060 via a network such as the Internet. The present embodiment is also configured to provide a module that performs respective plane data generation processing of the host device 10 according to the first embodiment and the clear processing 56 of the DFE 50 according to the first embodiment in the server device 3060.

A connection configuration of the host device 3010, the DFE 3050, the MIC 60, the printer machine 70, the glosser 80, and the low-temperature fixing device 90 is the same as that of the first embodiment.

Specifically, the third embodiment is configured that the host device 3010 and the DFE 3050 are connected to the server device 3060 as a single device via the network (cloud) such as the Internet, that the server device 3060 includes a plane data generating unit 3062, a print data generating unit 3063, and a clear processing 3066, and that the server device 3060 performs the plane data generation processing for generating color plane data, clear plane data, and gloss-control plane data, the print data generation processing, and the clear-toner plane data generation processing.

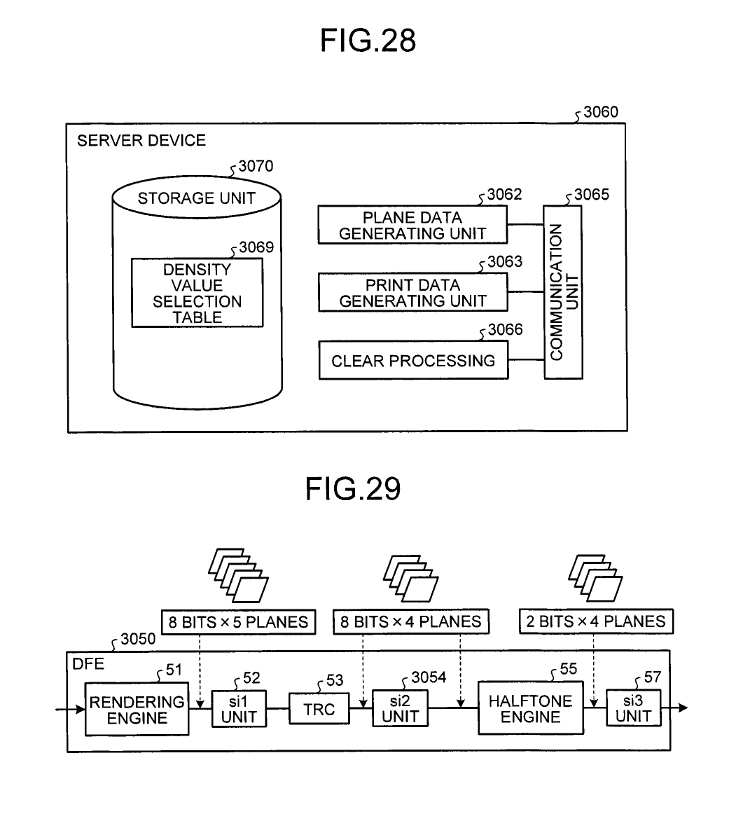

The server device 3060 will be explained first. FIG. 28 is a block diagram of a functional configuration of the server device 3060 according to the third embodiment. As illustrated in FIG. 28, the server device 3060 includes a storage unit 3070, the plane data generating unit 3062, the print data generating unit 3063, the clear processing 3066, and a communication unit 3065.

The storage unit 3070 is a storage medium such as a HDD or a memory, and stores a density value selection table 3069. The density value selection table 3069 is the same as the density value selection table 3069 according to the first embodiment explained with reference to FIG. 6.

The communication unit 3065 transmits or receives various data and requests to or from the host device 3010 and the DFE 3050. More specifically, the communication unit 3065 receives image specifying information and specification information and receives a print data generation request from the host device 3010, and transmits the generated print data to the host device 3010. Moreover, the communication unit 3065 receives the 8-bit gloss-control plane image data, the 8-bit color plane image data, and a clear toner plane generation request from the DFE 3050, and transmits the generated clear toner plane image data and the on-off information to the DFE 3050.

The plane data generating unit 3062 generates color plane data, gloss-control plane data, and clear plane data in the same manner as that of the host device 10 according to the first embodiment.

The print data generating unit 3063 according to the present embodiment generates the print data illustrated in FIG. 8 in the same manner as that of the host device 10 according to the first embodiment.

The clear processing 3066 has the same function as that of the clear processing 56 in the DFE 50 according to the first embodiment, and its functional configuration is the same as the functional configuration illustrated in FIG. 10.

The DFE 3050 will be explained next. FIG. 29 is a block diagram of a functional configuration of the DFE 3050 according to the third embodiment. The DFE 3050 according to the present embodiment includes the rendering engine 51, the si1 unit 52, the TRC 53, an si2 unit 3054, the halftone engine 55, and the si3 unit 57. The functions and the configurations of the rendering engine 51, the si1 unit 52, the TRC 53, the halftone engine 55, and the si3 unit 57 are the same as these of the DFE 50 according to the first embodiment.

The si2 unit 3054 according to the present embodiment transmits the 8-bit gloss-control plane data which is gamma corrected by the TRC 53, the respective 8-bit color plane data of CMYK, and a clear toner plane generation request to the server device 3060, and receives the clear toner plane data and the on-off information from the server device 3060.

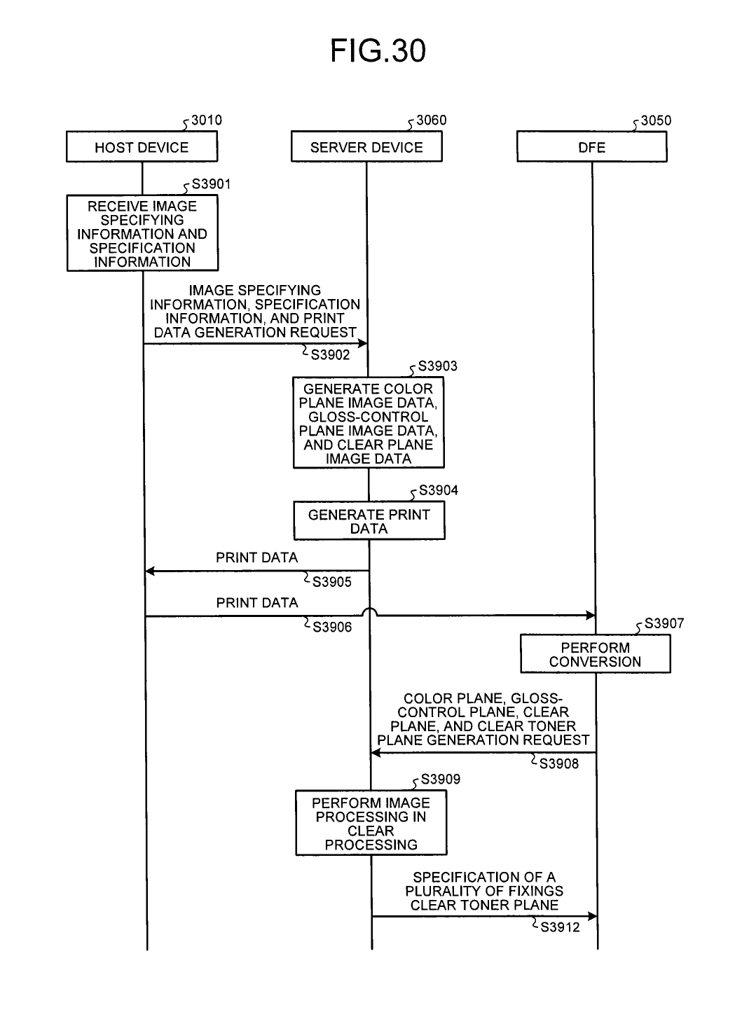

The clear-toner plane generation processing required for print processing performed by the image forming system according to the present embodiment configured in the above manner will be explained next. FIG. 30 is a sequence diagram of the overall flow of clear-toner plane generation processing according to the third embodiment.

First of all, the host device 3010 receives image specifying information and specification information from the user (Step S3901), and transmits a print data generation request together with the image specifying information and the specification information to the server device 3060 (Step S3902).

The server device 3060 receives the print data generation request together with the image specifying information and the specification information, and generates color plane image data, gloss-control plane image data, and clear plane image data (Step S3903). The server device 3060 generates print data from these image data (Step S3904), and transmits the generated print data to the host device 3010 (Step S3905).

When receiving the print data, the host device 3010 transmits the print data to the DFE 3050 (Step S3906).

When receiving the print data from the host device 3010, the DFE 3050 analyzes the print data to obtain the color plane image data, the gloss-control plane image data, and the clear plane image data, and performs conversion and correction or the like on these image data (Step S3907). The DFE 3050 transmits the color plane image data, the gloss-control plane image data, the clear plane image data, and a clear toner plane generation request to the server device 3060 (Step S3908).

When receiving the color plane data, the gloss-control plane data, the clear plane data, and the clear toner plane generation request, the server device 3060 causes the clear processing 3066 to perform image processing (Step S3909). The image processing performed by the clear processing 3066 is performed in the same manner as the processing in FIG. 17 according to the first embodiment.

The server device 3060 then transmits the clear toner plane data generated through the image processing by the clear processing 3066 and information for specification of a plurality of fixings to the DFE 3050 (Step S3912).

The processings in the subsequent MIC 60, printer machine 70, glosser 80, and low-temperature fixing device 90 are performed in the same manner as these in the first embodiment.

In the present embodiment, the color plane data, the gloss-control plane data, the clear plane data, the print data, and the clear toner plane data are generated by the server device 3060 in the cloud. Therefore, in addition to having the same effect as that of the first embodiment, changes and other processings of the density value selection table and the surface effect selection table can be collectively performed even if a plurality of host devices 3010 and DFEs 3050 are provided, which is convenient for managers.

The present embodiment is configured that the single server device 3060 in the cloud includes the plane data generating unit 3062, the print data generating unit 3063, and the clear processing 3066, and that the server device 3060 performs the plane data generation processing for generating color plane data, clear plane data, and gloss-control plane data, the print data generation processing, and the clear-toner plane data generation processing. However, the embodiment is not limited thereto.

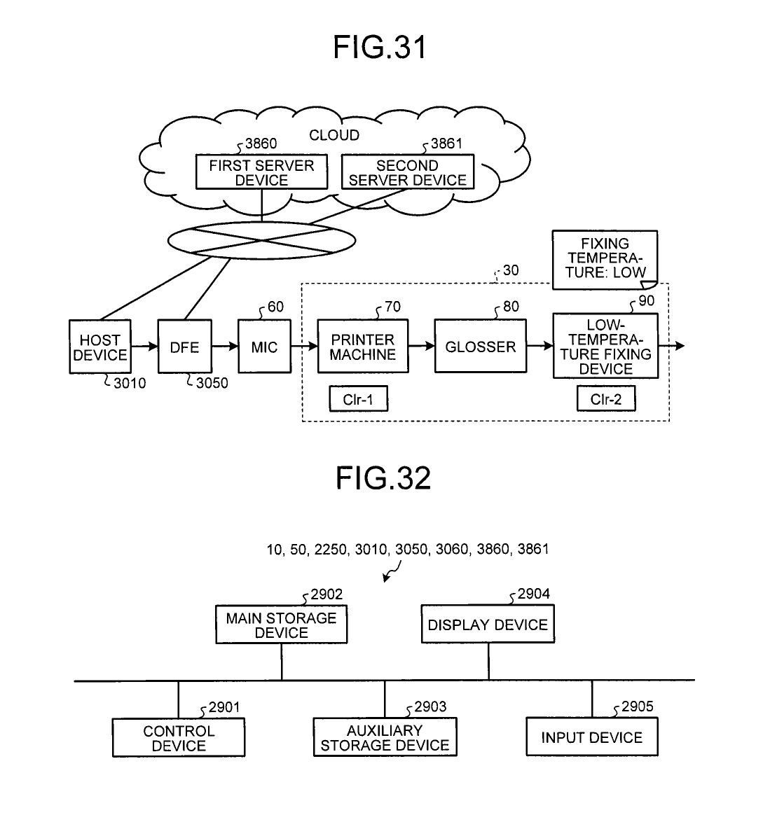

For example, it may be configured that two or more server devices are provided in the cloud and that the processings are distributed and executed by the two or more server devices. FIG. 31 is a diagram of a network configuration in which two servers (first server device 3860 and second server device 3861) are provided in the cloud. In the example of FIG. 31, it is configured so that the first server device 3860 and the second server device 3861 distribute and execute the plane data generation processing for generating color plane data, clear plane data, and gloss-control plane data, the print data generation processing, and the clear-toner plane data generation processing.

For example, it can be configured that the plane data generating unit 3062 and the print data generating unit 3063 are provided in the first server device 3860 and that the plane data generation processing and the print data generation processing are performed by the first server device 3860. It can also be configured that the clear processing 3066 is provided in the second server device 3861 and that the clear-toner plane data generation processing is performed by the second server device 3861. However, how to distribute the processings to the server devices is not limited thereto, and therefore the distribution can be arbitrarily performed.

More specifically, by providing minimum components in the host device 10 and the DFE 50, it can be arbitrarily provided in such a manner that part or whole of the plane data generating unit 3062, the print data generating unit 3063, and the clear processing 3066 are concentrated in a single server device in the cloud, or are distributed to a plurality of server devices.

In other words, as is the above example, it can be configured that any one of the processings performed in the signal device can be performed by one or any other devices connected to the single device via the network.

In the case of “such a configuration that any one of the processings is performed by one or any other devices connected to the single device via the network”, it is configured that the processing includes input-output processing of data performed between the single device and other devices and between other devices, the input-output processing being the processing of outputting data (information) generated in the processing performed by the single device from the single device to some other devices and the processing of receiving the data in the other devices.

In other words, when the other device is provided as one unit, it is configured that the processing includes input-output processing of data performed between the single device and the other device. When the other device is provided as two or more units, it is configured that the processing includes input-output processing of data performed between the single device and the other device and between other devices such as between a first other device and a second other device.

In the third embodiment, the server device 3060 or a plurality of server devices such as the first server device 3860 and the second server device 3861 are provided in the cloud; however, the embodiment is not limited thereto. For example, the server device 3060 or the server devices such as the first server device 3860 and the second server device 3861 may be configured to be provided on all types of networks such as on an intranet.

Furthermore, it may be configured to provide the output control unit 2251, the fixing temperature acquiring unit 2252, and the charging calculating unit 2253, which are included in the DFE 2250 according to the second embodiment, in the server device 3060.

A hardware configuration of the host devices 10 and 3010, the DFEs 50, 2250 and 3050, the server device 3060, the first server device 3860, and of the second server device 3861 according to the embodiments will be explained below. FIG. 32 is a hardware configuration diagram of the host devices 10 and 3010, the DFEs 50, 2250, and 3050, and the server device 3060. Each of the host devices 10 and 3010, the DFEs 50, 2250 and 3050, the server device 3060, the first server device 3860, and the second server device 3861 includes, as a hardware configuration, a control device 2901 such as CPU that controls the entire device, a main storage device 2902 such as a read-only memory (ROM) and a random access memory (RAM) that store various data and various programs, an auxiliary storage device 2903 such as a HDD that stores various data and various programs, an input device 2905 such as a keyboard and a mouse, and a display device 2904 such as a display. The hardware configuration is obtained by using a normal computer.

The image processing program (including the image processing application, hereinafter the same) executed by the host devices 10 and 3010 according to the embodiments is provided as a computer program product by being stored in a computer-readable storage medium such as a compact disk read only memory (CD-ROM), a flexible disk (FD), a compact disk recordable (CD-R), and a digital versatile disk (DVD) as a file in an installable format or in an executable format.

It may be configured so that the image processing program executed by the host devices 10 and 3010 according to the embodiments is provided by being stored on a computer connected to a network such as the Internet and being downloaded via the network. It may also be configured so that the image processing program executed by the host device 10 according to the embodiments is provided or distributed via a network such as the Internet.

Moreover, it may be configured so that the image processing program executed by the host devices 10 and 3010 according to the embodiments is provided as a computer program product by being preinstalled into ROM or the like.

The image processing program executed by the host devices 10 and 3010 according to the embodiments is configured with modules including the units (the plane data generating unit, the print data generating unit, the input control unit, and the display control unit). As actual hardware, the CPU (processor) reads the image processing program from the recording medium and executes the read image processing program, and the units are thereby loaded to the main storage device. Thus the plane data generating unit, the print data generating unit, the input control unit, and the display control unit are generated on the main storage device.

The print control processing executed by the DFEs 50, 2250, and 3050 according to the embodiments may be implemented by a print control program as software in addition to implementation by hardware. In this case, the print control program executed by the DFEs 50, 2250, and 3050 according to the embodiments is provided as a computer program product by being preinstalled into ROM or the like.

It may be configured so that the print control program executed by the DFEs 50, 2250, and 3050 according to the embodiments is provided as a computer program product by being stored in a computer-readable storage medium such as CD-ROM, FD, CD-R, DVD as a file in an installable format or in an executable format.

Moreover, it may be configured so that the print control program executed by the DFEs 50, 2250, and 3050 according to the embodiments is provided by being stored on a computer connected to a network such as the Internet and being downloaded via the network. It may also be configured so that the print control program executed by the DFE 50 according to the embodiments is provided or distributed via a network such as the Internet.

The print control program executed by the DFEs 50, 2250, and 3050 according to the embodiments is configured with modules including the units (the rendering engine, the halftone engine, the TRC, the si1 unit, the si2 unit, the si3 unit, and the clear processing). As actual hardware, the CPU (processor) reads the print control program from the ROM and executes the read print control program, and the units are thereby loaded to the main storage device. Thus the rendering engine, the halftone engine, the TRC, the si1 unit, the si2 unit, the si3 unit, and the clear processing are generated on the main storage device.

The data generation processing executed by the server device 3060 according to the embodiment may be implemented by a generation program as software in addition to implementation by hardware. In this case, the generation program executed by the server device 3060 according to the embodiment is provided by being preinstalled into ROM or the like.

It may be configured so that the data generation processing program executed by the server device 3060 according to the embodiment is provided as a computer program product by being stored in a computer-readable storage medium such as CD-ROM, FD, CD-R, DVD as a file in an installable format or in an executable format.

Moreover, it may be configured so that the data generation processing program executed by the server device 3060 according to the embodiment is provided by being stored on a computer connected to a network such as the Internet and being downloaded via the network. It may also be configured so that the data generation processing program executed by the server device 3060 according to the embodiment is provided or distributed via a network such as the Internet.

The data generation processing program executed by the server device 3060 is configured with modules including the units (the plane data generating unit, the print data generating unit, and the clear processing). As actual hardware, the CPU (processor) reads the generation program from the ROM and executes the read generation program, and the units are thereby loaded to the main storage device. Thus the plane data generating unit, the print data generating unit, and the clear processing are generated on the main storage device.

In the embodiments, the image forming system is configured to include the host devices 10 and 3010, the DFEs 50, 2250, and 3050, the MIC 60, the printer machine 70, the glosser 80, and the low-temperature fixing device 90; however, the embodiment is not limited thereto. For example, it may be configured so that the DFEs 50, 2250, and 3050, the MIC 60, and the printer machine 70 are integrally formed as one image forming apparatus, or it may be configured so that an image forming apparatus further including the glosser 80 and the low-temperature fixing device 90 is formed.

In the image forming system according to the embodiments, toners in the colors of CMYK are used to form an image; however, a toner in a single color may be used to form an image.

The printer system according to the embodiments is configured to include the MIC 60; however, the embodiment is not limited thereto. It may be configured not to provide the MIC 60 by causing the other devices such as the DFE 50 to perform the processing and the function executed by the MIC 60.

According to the embodiments, there are effects that a surface effect intended by the user can be obtained in a specified area to which the surface effect of increasing glossiness is applied even when a sheet has large surface roughness and that surface roughness of a sheet can be smoothed when the sheet has large surface roughness even when there is no specified area to which the surface effect of increasing glossiness is applied.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A print control device comprising an image data generating unit that generates image data based on gloss-control plane data for specifying a type of a surface effect to be applied to a recording medium and an area in the recording medium to which the surface effect is applied, wherein
the image data generating unit generates image data used to fix only a clear toner at a first fixing in response to an instruction to perform a plurality of fixings.

2. The print control device according to claim 1, further comprising a fixing condition determining unit that determines whether toner can be fixed on the recording medium a plurality of times based on attribute information for the recording medium,
wherein the image data generating unit generates, when the fixing condition determining unit determines that toner can be fixed on the recording medium a plurality of times, the image data used to fix only a clear toner at the first fixing on an area in the recording medium to which the surface effect of increasing glossiness is applied.

3. The print control device according to claim 2, wherein the image data generating unit generates, when the fixing condition determining unit determines that toner can be fixed a plurality of times, image data used to fix a toner in at least one color of a color toner and a clear toner at second and subsequent fixings.

4. The print control device according to claim 1, wherein the image data generating unit generates, when the fixing condition determining unit determines that toner cannot be fixed a plurality of times, the image data used to fix a toner in at least one color of a color toner and a clear toner by one fixing.

5. The print control device according to claim 3, further comprising:
a fixing temperature acquiring unit that acquires a fixing temperature of a fixing device; and
an output control unit that controls an output of the image data based on the fixing temperature, wherein
the fixing condition determining unit further determines whether the fixing temperature is equal to or higher than a fixing temperature of a clear toner, and
the output control unit outputs, when the fixing condition determining unit determines that toner can be fixed a plurality of times and that the fixing temperature is equal to or higher than a fixing temperature of a clear toner, the image data that is generated by the image data generating unit and is used to fix only a clear toner at the first fixing on the area in the recording medium to which the surface effect of increasing the glossiness is applied.

6. The print control device according to claim 5, wherein
the fixing condition determining unit further determines whether the fixing temperature is equal to or higher than a fixing temperature of a color toner, and
the output control unit outputs, when the fixing condition determining unit determines that the fixing temperature is equal to or higher than a fixing temperature of a color toner, the image data that is generated by the image data generating unit and is used to fix a color toner at the second and substrate fixings.

7. The print control device according to claim 1, further comprising a charging calculating unit that performs charging processing on printing based on the image data used to fix only a clear toner on the recording medium at the first fixing.

8. The print control device according to claim 7, wherein the charging calculating unit performs the charging processing in response to an instruction from a user.

9. The print control device according to claim 1, further comprising an input control unit that receives a specification as to whether toner is to be fixed on the recording medium a plurality of times.

10. The print control device according to claim 1, further comprising a surface effect selection table storage unit that stores surface effect selection information in which the type of the surface effect is registered according to a density value of the clear toner, wherein
the gloss-control plane data includes a density value corresponding to the surface effect given to an area in the recording medium to which the surface effect is applied, and
the image data generating unit generates the image data based on the surface effect selection information and the gloss-control plane data.

11. A print control method comprising generating image data based on gloss-control plane data for specifying a type of a surface effect to be applied to a recording medium and an area in the recording medium to which the surface effect is applied, wherein
the generating includes generating image data used to fix only a clear toner at a first fixing in response to an instruction to perform a plurality of fixings.

12. A non-transitory computer-readable storage medium with an executable program stored thereon and executed by a computer, wherein the program instructs the computer to perform: generating image data based on gloss-control plane data for specifying a type of a surface effect to be applied to a recording medium and an area in the recording medium to which the surface effect is applied, wherein
the generating includes generating image data used to fix only a clear toner at a first fixing in response to an instruction to perform a plurality of fixings.
